(19) United States
(12) Patent Application Publication
(10) Pub. No.: US 2024/0227698 A1
(43) Pub. Date: Jul. 11, 2024

(54) ATTACHMENT DEVICE FOR ATTACHING A COMMUNICATION COMPONENT TO AN OBJECT

(71) Applicant: Christopher A.P. Pettenaro, Melissa, TX (US)

(72) Inventor: Christopher A.P. Pettenaro, Melissa, TX (US)

(21) Appl. No.: 18/094,777

(22) Filed: Jan. 9, 2023

(51) Int. Cl. B60R 13/10; G09F 17/00

(52) U.S. Cl. CPC B60R 13/105; G09F 17/00; G09F 2017/0075

(57) ABSTRACT

Methods, systems, and apparatus for coupling a flag to a vehicle to display a message during transportation. In some implementations, a device includes an attachment rod and a flag. The attachment rod is configured to be coupled to at least two screw holes used to couple a license plate to a vehicle, the attachment rod having defined therein at least two openings configured to correspond to the at least two screw holes and each of the at least two openings is configured to receive one or more attachment components in order to couple the attachment rod to the at least two screw holes. The flag comprising an elongated opening defined therein for receiving a portion of the attachment rod through the elongated opening to couple the flag to the attachment rod.

### TECHNICAL FIELD

This specification relates generally to an attachment device, and more specifically, an attachment device capable of attaching a communication or message component to an object, such as a vehicle, trailer, wall, or window.

### BACKGROUND

A message can include any type of communication intended by a source for consumption by some recipient or group of multiple recipients. The message may be delivered by various means, for example, electronically, visually, through courier, and other types of delivery. Messages can also be exchanged in an interactive manner between multiple parties, creating a conversation by which various communications can be exchanged between the multiple parties.

### SUMMARY

The techniques described in this specification can include a device that couples a communication component to a particular object for displaying a desired message. The communication component can include any component utilized for displaying the desired message such as for example, a flag, a banner, a brand logo, one or more sheets of paper, an electronic display board, and other components. The particular object to which the communication component can be coupled can include any surface capable of attaching, maintaining, and displaying the communication component. For example, the surface can include any surface of a vehicle, a stationary object, a movable object, or any other type of object. The communication component can be configured to display any type of advertisement, thought, phrase, or visual object for communicating the desired message to an audience.

The device that couples the communication component to the particular object can utilize various components for coupling the communication component to the particular object for displaying the desired message. The various coupling components can include, for example, attachment devices, retention devices, non-retention devices, threaded devices, pole or dowel rods, adhesive devices, suction cup devices, snap-fit devices, bracket components, and other devices, to name some examples. The various coupling components can be selected according to various criteria. For example, depending on size, complexity, or dimensionality of the message to be displayed, a user or designer can select the coupling components to sufficiently handle the coupling of the message to the particular object. Moreover, in an event the particular object is movable, the designer or user can select and apply one or more additional coupling components to the particular object to ensure the message to be displayed can be supported by the particular object during one or more potential movements of the message during its coupling to the particular object.

In some examples, a flag or banner that displays a message can be coupled to an attachment device of a vehicle. Specifically, the attachment device can include one or more bracket components that attaches behind a surface of a license plate on the vehicle. The bracket components can be positioned between a rear surface of the license plate and a mounting surface of a vehicle, enabling a secured attachment device to the vehicle. One or more screws can be inserted into various screw-holes of the license plate to secure the license plate and the one or more bracket components to the vehicle. In some examples, a pole or dowel rod can be coupled to a portion of the attachment device. The pole or dowel rod can accept the flag, banner, or other communication component in a desired configuration to display the communication component on the vehicle while, for example, the vehicle traverses a road surface or the vehicle is parked. This will be further described below.

In one general aspect, a device includes an attachment rod configured to be coupled to at least two screw holes used to couple a license plate to a vehicle, the attachment rod having defined therein at least two openings configured to correspond to the at least two screw holes and each of the at least two openings is configured to receive one or more attachment components in order to couple the attachment rod to the at least two screw holes; and a flag including an elongated opening defined therein for receiving a portion of the attachment rod through the elongated opening to couple the flag to the attachment rod.

Other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other implementations can each optionally include one or more of the following features, alone or in combination. For example, one implementation includes all the following features in combination.

In some implementations, the flag includes at least two openings defined therein, the at least two openings of the flag configured to enable the one or more attachment components to pass at least partially through the openings to couple the flag and attachment rod to the at least two screw holes used to couple the license plate to the vehicle.

In some implementations, the one or more attachment components include a base portion configured to be coupled to one of the at least two screw holes used to couple the license plate to the vehicle and an upper portion configured to be releasably coupled to the base portion.

In some implementations, the attachment rod includes raised portions at each end of the attachment rod, the raised portions configured to retain the flag on the attachment rod.

In some implementations, the attachment rod includes a longitudinal slot defined therein, the longitudinal slot configured to receive a portion of the flag along the elongated opening defined in the flag to couple the flag to the attachment rod.

In some implementations, the attachment components are configured to releasably couple the attachment rod to the at least two screw holes.

In some implementations, a device includes: an attachment bracket including a first component and a second component, the first component and the second component having defined therein at least two openings configured to correspond to at least two screw holes used to couple a license plate to a vehicle; an attachment rod configured to be releasably coupled to the first and second components of the attachment bracket; and a flag including an elongated opening defined therein for receiving a portion of the attachment rod through the elongated opening to couple the flag to the attachment rod.

In some implementations, the flag includes at least two openings defined therein, the at least two openings of the flag configured to enable coupling of the attachment rod to the first and second components of the attachment bracket.

In some implementations, the device further includes one or more attachment components including a base portion configured to be coupled to the attachment bracket and an upper portion configured to releasably couple the attachment rod to the attachment component.

In some implementations, the attachment rod includes raised portions at each end of the attachment rod, the raised portions configured to retain the flag on the attachment rod.

In some implementations, the attachment rod includes a longitudinal slot defined therein, the longitudinal slot configured to receive a portion of the flag along the elongated opening defined in the flag to couple the flag to the attachment rod.

In some implementations, the first and second components of the attachment bracket are configured to be coupled to the at least two screw holes in one of a horizontal configuration or vertical configuration.

In some implementations, a device includes: a plurality of attachment components, the plurality of attachment components each including a base portion and an upper portion; an attachment rod configured to be releasably coupled to the plurality of attachment components between the base portion and upper portion; and a flag including an elongated opening defined therein for receiving a portion of the attachment rod through the elongated opening to couple the flag to the attachment rod.

In some implementations, the flag includes at least two openings defined therein, the at least two openings of the flag configured to enable at least one of the plurality of attachment components to pass at least partially through the openings to couple the flag and attachment rod to the at least one of the plurality of attachment components.

In some implementations, the attachment rod includes raised portions at each end of the attachment rod, the raised portions configured to retain the flag on the attachment rod.

In some implementations, the upper portion of the plurality of attachment components is movable with respect to the base portion.

In some implementations, the upper portion of the plurality of attachment components is substantially D-shaped.

In some implementations, the base portion includes one of an adhesive, suction cup, or magnet.

In some implementations, a method of attaching a flag to a vehicle including: attaching one or more attachment components to a vehicle surface, the one or more attachment components each including a base portion and an upper portion; passing an attachment rod through an elongated opening defined in a flag; and releasably coupling the attachment rod and the flag to the one or more attachment components such that the attachment rod is between the base portion and upper portion of the one or more attachment components.

In some implementations, attaching the one or more attachment components to a vehicle surface includes a use of an adhesive, suction cup, magnet, snap-fit, or threaded connection.

The subject matter described in this specification can be implemented in various ways and may result in one or more of the following advantages. In some implementations, the attachment mechanism can enable a message to be displayed in various conditions. For example, a flag or banner that is displayed on a moving vehicle can be secured by the attachment mechanism such that the flag or banner is not released by external forces, such as weather, wind, vehicular drag, or other. Rather, the flag or banner and the attachment mechanism can only be released upon a user seeking to remove the flag and/or the attachment mechanism for replacement or removal. The various implementations allow for a great deal of specificity as to how a user desires to display a flag or message on a vehicle or other suitable surface, device, or object, whether permanently or semi-permanently, with the ability to remove the flag from said surface or base retention portion at-will, such as before entering a car-wash or when replacing the message with a new message, e.g., a different flag, banner, log, or other, as desired.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-1F are block diagrams that illustrate examples of systems that include various devices for coupling a flag or banner to a license plate or license plate frame of a vehicle.

FIGS. 2A-2B, and 3 are block diagrams that illustrate examples of systems that include various retention devices for coupling a flag or banner to a license plate or license plate frame of a vehicle.

FIGS. 4A-4F are block diagrams that illustrate examples of systems that include various devices for coupling a flag or banner to a windshield wiper of a vehicle.

FIG. 5A is a block diagram that illustrate an example of various orientations for coupling a flag or banner to a windshield wiper of a vehicle.

FIGS. 5B-5E are block diagrams that illustrate examples of various devices utilized for coupling a flag or banner to a surface of a vehicle, such as a windshield wiper blade of a vehicle.

Like reference numbers and designations in the various drawings indicate like elements. The components shown here, their connections and relationships, and their functions, are meant to be examples only, and are not meant to limit the implementations described and/or claimed in this document, or the other suitable uses of the system(s) on other suitable surfaces and objects such as windows or walls, whether related or not, to a vehicle.

### DETAILED DESCRIPTION

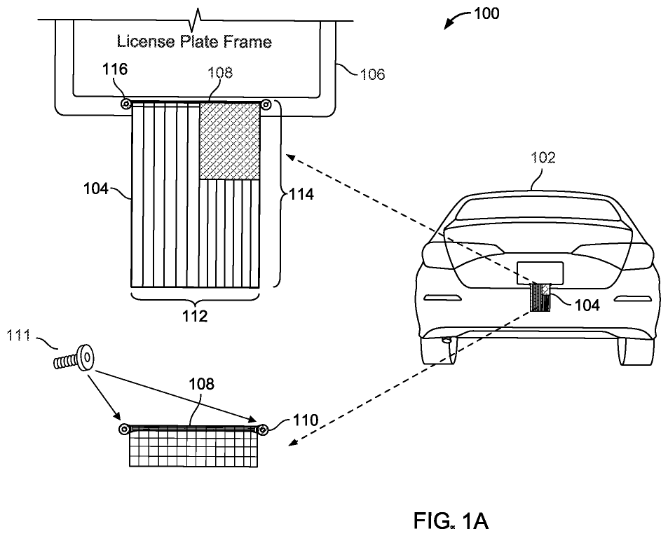

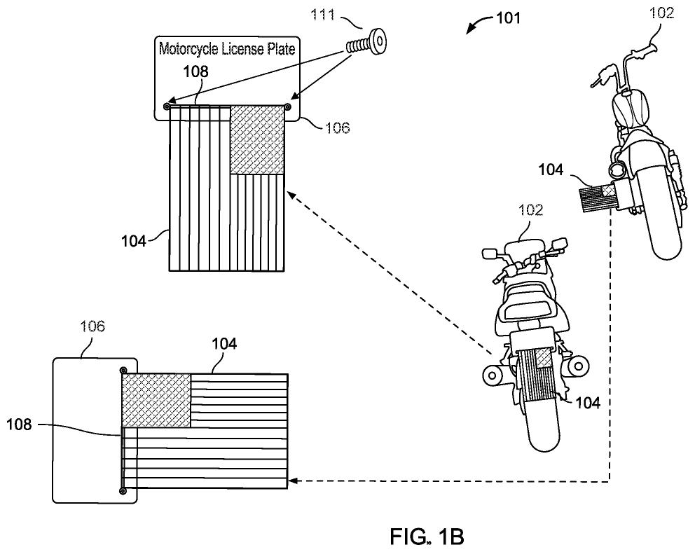

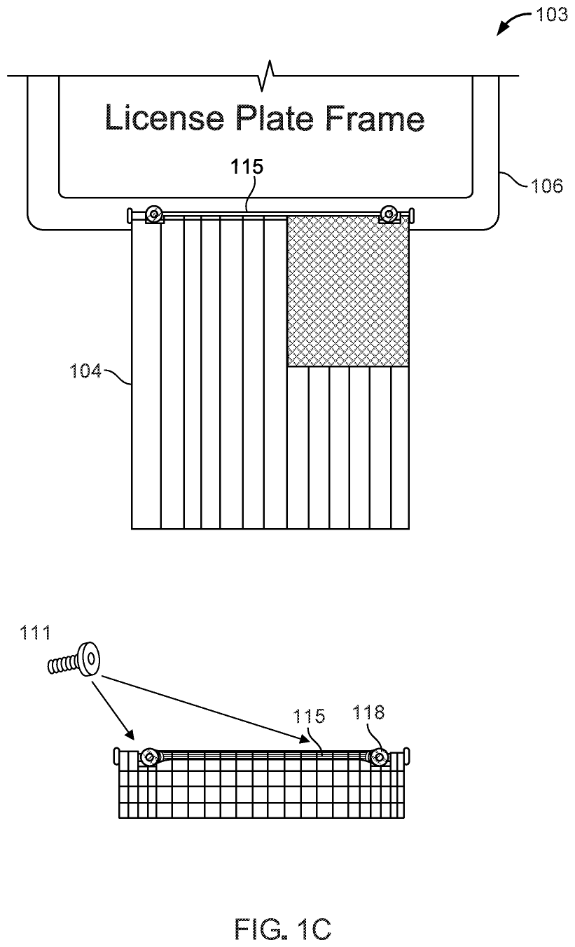

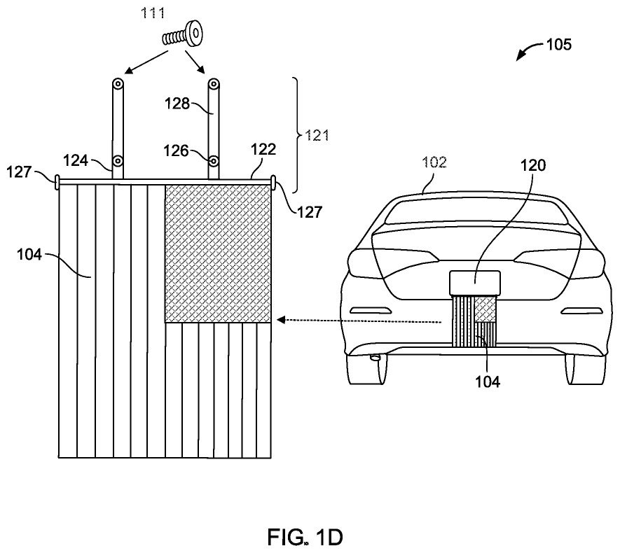

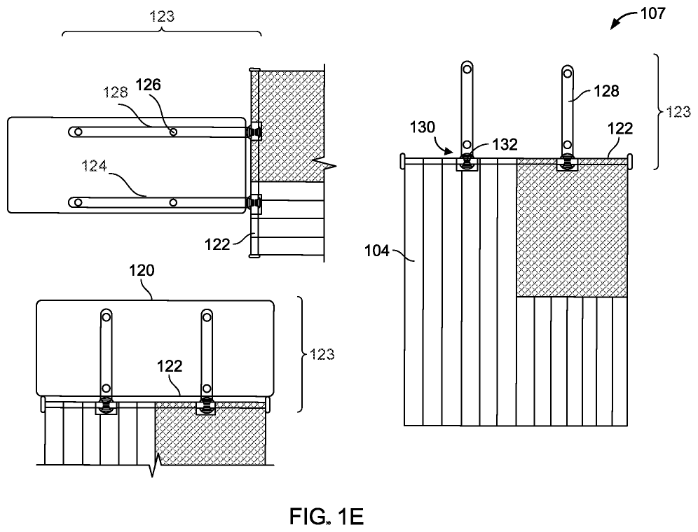

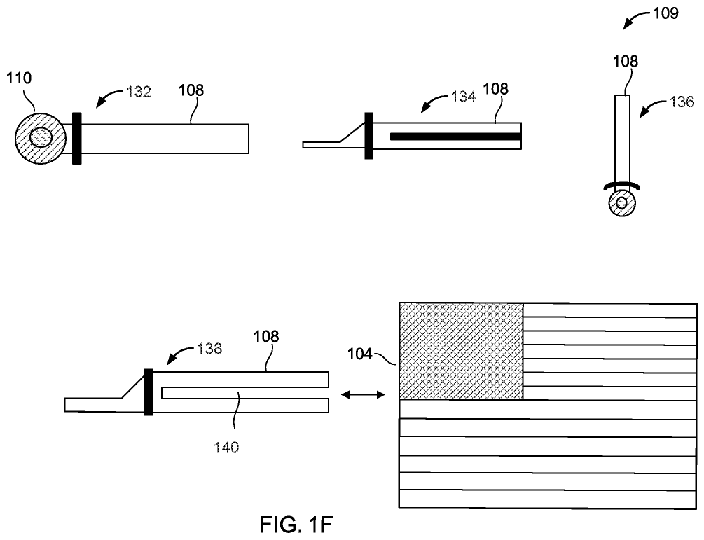

FIG. 1A is a block diagram that illustrates an example of a system 100 that includes various devices for coupling a communication or message component, such as a flag or banner, to a license plate of a vehicle. In some implementations, the system 100 can include various components and devices that can attach any type of communication component to a particular object to be displayed to a desired audience. The communication component can include, for example, any type of flag, banner, brand logo, message, or similar device to be displayed and communicated to the desired audience. The communication component can be created out of any suitable material that enables the desired audience to view the communication component during its attachment to the particular object and to withstand any environmental components that can affect the desired audience's visibility of the communication component.

As illustrated in system 100, a vehicle 102 can display a flag 104 on a portion of the vehicle. In some examples, the flag 104 can be attached to the license plate and license plate frame 106 of the vehicle 102 through various mechanisms. However, the flag 104 can also be attached to other objects or surfaces of the vehicle. For example, and as will be further elaborated upon below, the flag 104 can be attached to a wiper blade housing of the vehicle. In some examples, the flag 104 can be attached to any surface or component of any car, truck, trailer boat, motorcycle, sports utility vehicle (SUV), bus, golf cart, autonomous terrain vehicle (ATV), dune buggy, motor home, construction machinery, wave-runner, tractor plane, helicopter, or any other object, vehicle, or surface type. For example, the flag 104 can be attached to a window, bumper, body panel, or other component of the vehicle using one or more of the attachment mechanisms described in this specification. The flag, banner or similar communication device can also be wrapped around the various rod and attachment components, being secured semi-permanently by gluing, sewing or fusing the flag or banner material together through application of heat, or similar.

In some implementations, the flag 104 can be attached to stationary objects. The stationary objects can include, for examples, walls, windows, fences, painted surfaces, metallic surfaces, glass surfaces, wooden surfaces, and other types of surfaces. These stationary objects can be found within a residential area, a commercial area, an apartment building, a barn, a shed, a garage, a grocery store, and any other locations where a flag can be displayed. In some examples, the flag 104 can also be different communication components to display a message. The flag 104 can be a banner, a logo, a sheet of paper, a sheet of cloth, or another type of advertisement. The other type of advertisement can display a brand or campaign name, a symbol, a school, a team, a company name, a state, a country, a provincial flag design, a slogan, holiday celebration, logo, message, political affiliation, drawing, or otherwise, as imaginable and suitable by the designer of system 100. A length of the flag 104 can be, for example, 9.0, 9.5, or 10 inches or another suitable length. A width of the flag can be, for example, 6.0, 6.5, 6.625, or 7 inches or another length.

In some implementations, the system 100 enables the flag 104 to be coupled to a license plate frame 106 of the vehicle 102 by way of a coupling mechanism. The system 100 can include various coupling mechanisms 108 for attaching a flag 104 or other communication component to a license plate mounting point of an object's surface. For example, as illustrated in system 100 in FIG. 1A, the coupling mechanism can include a screw-based retention device 110, 111 or other device that enables the attachment of flag 104 to the vehicle 102.

In some implementations, the license plate frame 106 can have various configurations. Specifically, the license plate frame 106 can include one or more screw holes, no screw holes, various placements, and size of retention device on the frame 106, a thickness of the license plate frame, and varying thickness or slimness of individual components of the license plate frames 106. These configurations can enable the license plate frame 106 to display a logo, writing, a design, or another type of message.

The screw-based retention device can include an attachment rod 108 or dowel rod that includes one or more eyelets 110. In some examples, the attachment rod 108 can be configured to retain the flag 104 or another similar communication component in between the eyelets 110. The attachment rod 108 can be created from one or more of plastic, metal, wood, rubber, graphite, metal composite, carbon black, fiberglass, or of any other suitable material, such as a combination of the one or more of the aforementioned components.

In some implementations, the attachment rod 108 can retain or accept the flag 104 prior to the attachment rod 108 being mounted to the license plate or license plate frame 106. Specifically, a portion of the flag 104 can include an elongated opening, enclosed hole, or enclosed housing that traverses a width 112 or length 114 of the flag 104. The attachment rod 108 can be inserted into one end of the elongated opening of the flag 104 until a length of the attachment rod 108 traverses a length 114 or width 112 of the flag 104. In this manner, the attachment rod 108 can retain a portion of the flag 104 on the attachment rod 108. The flag 104 can also be wrapped around the attachment rod 108 and fused, sown or glued together, before being attached on-top of the license plate or license plate frame 106. In this manner, the attachment rod 108 can retain a portion of the flag 104 for display on the vehicle or other suitable surface and object permanently and semi-permanently on the attachment rod 108.

In some examples, when the attachment rod 108 is inserted through the elongated opening of the flag 104, a width 112 or length 114 of the flag 104 can be positioned in between the eyelets 110 of the attachment rod 108. In this example, the eyelets 110 of the attachment rod 108 or a portion of the eyelets 110 can extend outside of the elongated opening of the flag 104. In some examples, when the attachment rod 108 is inserted through the elongated opening of the flag 104, a width 112 or length 114 of the flag 104 can cover or substantially cover the eyelets 110 of the attachment rod 108. In the latter example, the elongated opening of the flag 104 can include one or more openings at the position of the eyelets 110. One or more screws 111 can pass through the one or more holes or openings in the retained flag 104, and the one or more screws 111 can pass through the one or more eyelets 110 of the attachment rod 108, and subsequently through the one or more screw holes 116 of the license plate frame 106 to releasably secure the attachment rod 108 and the flag 104 on-top of the license plate or the license plate frame 106. In this manner, the screws 111 do not pass through the material of the flag 104, which prevents damaging the integrity of the flag 104. In some examples, a width of the screws 111 can include, for example, 0.375 inches or another width.

In some implementations, the attachment rod 108 can be a permanent fixture of the license plate frame 106 or made integral with the license plate frame 106. The permanent fixture can be, for example, the attachment rod 108 embedded within a bottom portion or side portion of the license plate frame 106. In this manner, the attachment rod 108, the license plate frame 106, and a corresponding flag 104 can be provided as a single device or assembly of components.

In some implementations, the raised portions at each end of the attachment rod 108 can be a permanent fixture of the license plate frame 106. In this manner, the attachment rod 108 and the retained flag 104 can be easily removed and/or replaced from the license plate frame 106 and the corresponding raised portions that retain the flag 104. These raised portions can be clips, bars, screws, bolts, or other components that retain the flag 104 on the attachment rod 108 and that can be permanently fixed to the license plate frame 106. These raised portions can be positioned at each end of the attachment rod 108, as well as near the attachment points.

In some implementations, a designer can align the one or more eyelets 110 of the attachment rod 108 with the one or more screw holes 116 of the license plate frame 106 of the vehicle 102, or other acceptable holes or screw mounting holes on the vehicle 102. The attachment rod 108 can be mounted at the aligned position using various attachment components. These attachment components can include, for example, screws, nails, zip-ties, bolts, snap-fit connector, magnets, and other components that enable the attachment rod 108 to be mounted to the license plate frame 106 of the vehicle 102. For example, as illustrated in system 100, the attachment rod 108 can be releasably mounted to two bottom screw holes 116 by inserting a screw 111 through each eyelet 110 of the attachment rod 108 and pass the screw 111 to the two bottom screw holes 116 of the license plate or license plate frame 106. The screwing of the screws 111 into the eyelets 110 and the screw hole 116 can secure the attachment rod 108 to the license plate or license plate frame 106. As mentioned above, the screws 111 can pass through the one or more holes in the elongated opening of the flag 104, through the eyelets 110, and through the one or more screw holes 116. A distance between two screw holes 116 on the horizontal plane can include, for example, 7 inches or another length. A length of one screw hole of the screw holes 116 can include, for example, 0.375 inches or another length.

In some examples, a license plate can include two holes to secure the license plate to the vehicle. In some examples, a license plate can include four holes to secure the license plate to the vehicle. In the example of system 100, if the license plate frame 106 includes four holes, the pole rod 108 can be configured around the license plate frame 106 in various manners. For example, the attachment rod 108 can be aligned and mounted in a horizontal manner across the bottom two-screw holes of the license plate frame 106 or the top two screw holes of the license plate frame 106. The retained flag 104 can hang in a vertical manner when the attachment rod 108 and the retained flag 104 are mounted and aligned to either the bottom or top two-screw holes of the license plate frame 106. In some examples, the attachment rod 108 can be aligned and mounted in a vertical manner across the far right two-screw holes or the far left two-screw holes of the license plate frame 106. The retained flag 104 can extend in a horizontal manner to the left (when facing the rear of vehicle 102) when the attachment rod 108 and the retained flag are mounted to the far left two-screw holes of the license plate frame 106. Similarly, the retained flag 104 can extend in a horizontal manner to the right (when facing the rear of vehicle 102) when the attachment rod 108 and the retained flag are mounted to the far right two-screw holes of the license plate frame 106.

FIG. 1B is a block diagram that illustrates an example of a system 101 that includes various devices for coupling a flag to a license plate of a vehicle. The system 101 can include similar components, methods, and devices utilized in system 100. Specifically, as illustrated in system 101, a motorcycle 102 can display a flag 104 on a particular portion of the motorcycle. The flag 104 can be attached to a license plate frame 106 of the motorcycle 102 through various mechanisms and in various configurations. For example, the flag 104 can be retained by an attachment rod 108 mechanism and attached to the license plate or license plate frame 106 using one or more screws 111, such as that described with respect to system 100. In some examples, the flag 104 and attachment rod 108 can be attached or coupled to the motorcycle 102 using other mechanisms as described herein.

FIG. 1C is a block diagram that illustrates an example of a system 103 that includes various devices for coupling a flag to a license plate of a vehicle. In some implementations, the system 103 can include similar components, methods, and devices utilized in systems 100 and 101. Specifically, as illustrated in system 103, the flag 104 can be attached to the license plate or license plate frame 106 of a vehicle through various mechanisms and in various configurations. For example, the flag 104 can be retained by an attachment rod 115 mechanism and attached to the license plate or license plate frame 106 using one or more screws 111, such as that described with respect to systems 100 and 101.

In some examples, the attachment rod 115 can be similar to the attachment rod 108. In some examples, the attachment rod 115 can be different from the attachment rod 108. The attachment rod 115 can be an extendable/retractable or a fixed-length rod that extends past the eyelets 118 as shown for example in FIG. 1C. The attachment rod 115 can be extended an amount equivalent to a total length of the attachment rod 115 in a horizontal direction on both sides of the eyelets 118. The attachment rod 115 can be extended to retain larger flags, banners, and logos that cannot be retained by a smaller attachment rod, such as attachment rod 108. Particularly, the attachment rod 115 can be scaled to exponentially larger or smaller rods depending on the desired application and requirements. In some examples, the attachment rod 115 can be extended longer than a length or width of the license plate frame 106. In some examples, the attachment rod 115 can be extended longer than a length of the rear bumper of the vehicle.

In some implementations, the attachment rod 115 can shorten its length. Specifically, a designer or user of the system 103 can shorten a length of the attachment rod 115 to a desired length. In some examples, the shortened length can be a length smaller than a length of the rear bumper of the vehicle, equivalent to the length of the license plate, or less than the length of the license plate. The desired length of the attachment rod 115 can be set according to the desired application and requirements.

In some implementations, a length of the attachment rod 115 can be at least a width of the two mounting points at the license plate screw holes or greater. In some examples, a flag smaller than the width of the mounting holes can be attached to the attachment rod 115. A flag smaller than the width of the mounting holes would necessitate the flag being positioned in a desired place on the attachment rod 115. As mentioned the flag can be secured using a sewing method, a fusing method, or other, and then aided in being kept in position through the use of clips or raised portions, such as clips 127 that are found on each end of the attachment rod 115.

FIG. 1D is a block diagram that illustrates an example of a system 105 that includes various devices for coupling a flag to a license plate of a vehicle. The system 105 can include similar components, methods, and devices utilized in systems 100, 101, 103. Specifically, as illustrated in system 105, a vehicle 102 can display a flag 104 on a particular portion of the vehicle 102. The flag 104 can be attached to the license plate 120 of the vehicle 102 through various mechanisms and in various configurations. For example, and as will be described below, the flag 104 can be retained by a bracket mechanism 121 that connects between a rear surface of license plate 120 and mounting holes of the license plate 120 defined within a portion of the body of the vehicle.

In some implementations, the bracket mechanism 121 can be created from one or more of plastic, metal, wood, carbon fiber, or any other suitable materials. The bracket mechanism 121 can include a first elongated bracket 124 and a second elongated bracket 128. The first elongated bracket 124 and the second elongated bracket 128 can be positioned behind a rear surface of the license plate 120 and the mounting hole for the license plate 120 defined within a portion of the body of the vehicle. A front surface of the license plate 120 can include a surface positioned away from the vehicle 102. The rear surface of the license plate 120 can include a surface positioned towards a surface of the vehicle 102. Moreover, the rear surface of the license plate 120 can come in contact with the surface of the vehicle 102. The first elongated bracket 124 and the second elongated bracket 128 can be positioned between the rear surface of the license plate 120 and the surface of the vehicle 102.

In some implementations, each of the first bracket 124 and the second bracket 128 can include one or more screw holes 126. The screw holes 126 can be positioned in a location along each of the corresponding elongated brackets 124, 128 that aligns with the screw hole positions of the license plate 120. In this manner, when the bracket mechanism 121 is positioned such that (i) the first bracket 124 and the second bracket 128 are aligned at the rear surface of the license plate 120 and (ii) the screw holes 126 of each of the brackets 124 and 128 align with the screw holes of the license plate 120, one or more screws 111 can pass through the screw holes and releasably secure the bracket mechanism to the license plate 120 and/or the mounting screw holes for the license plate 120 defined within a portion of the surface of the vehicle. Said another away, a designer or user passing the one or more screws 111 through each of the screw holes, i.e., screw holes of the license plate 120 and screw holes 126, can secure the license plate 120 and the bracket mechanism 121 to the mounting screw holes for the license plate 120 defined within a portion of the surface of the vehicle.

A distance between each screw hole on a corresponding bracket, e.g., first bracket 124 or second bracket 128, can be, for example, 4.6875 inches or another distance. A width of a screw hole on the first elongated bracket 124 and the second elongated bracket 128 can be, for example, 0.5 inches or another width. A distance between the first bracket 124 and the second bracket 128 can be, for example, 7 inches or another distance. A length of flag 104 can be, for example, 14 inches or another length. A width of flag 104 can be, for example, 12 inches or another width. A width of one of the first elongated bracket 124 or the second elongated bracket 128 can be, for example, 0.28125 inches, 0.3 inches, or another suitable width.

In some implementations, the bracket mechanism 121 can be aligned and mounted to any surface or component of any vehicle. For example, the bracket mechanism 121 can be aligned and mounted to any surface of a car, truck, trailer boat, motorcycle, SUV, bus, golf cart, ATV, dune buggy, motor home, construction machinery, wave-runner, tractor, plane, helicopter, or to any other vehicle type. Similarly, the bracket mechanism 121 can be aligned and mounted to other stationary objects, such as those previously mentioned and including a wall, a trailer, a pipe, or another stationary object type. In these implementations, when the bracket mechanism 121 is aligned and mounted to a surface of a movable or a stationary object, the bracket mechanism 121 can include an attachment rod 122 that retains a flag 104, a banner, or other message to be displayed. In some examples, the attachment rod 122 that retains the message to be displayed can be secured to the bracket mechanism 121 or releasably secured to the bracket mechanism 121.

In some implementations, the bracket mechanism 121 can include an attachment rod 122. In some examples, the attachment rod 122 can be similar to the attachment rod 108. In some examples, the attachment rod 122 can be a permanent fixture that attaches to a bottom portion of the bracket mechanism 121. In this example, the attachment rod 122 can attach to both the first bracket 124 and the second bracket 128. The attachment rod 122 can include one or more clips or raised ends 127 at opposite ends to retain a flag 104 or message to be produced. Similar to the attachment rod 108, the attachment rod 122 can retain or accept the flag 104 prior to the attachment rod's 122 fixture to the bracket mechanism 121. The attachment rod 122 can be inserted into one end of an elongated opening of the flag 104 until a length of the attachment rod 122 traverses a length or width of the flag 104. A flag 104 can also be wrapped around the attachment rod 122 and have cutouts for brackets 124 and 128 and be secured around it through the use of heat, glue, sowing or other acceptable attachment method, allowing it to be displayed the width of system 105. In response to inserting the attachment rod 122 through the elongated opening of the flag 104, a designer or user can attach a clip of the one or more clips, a raised end, or another component 127 at each opposite end of the pole rod 122 to retain the flag 104. The clips 127 can be attached by, for example, snapping, clicking, tying, screwing, or performing another type of attachment to mount the clips to the end of the pole rod 122. In some implementations, the clips, raised end, or other components 127 can be used to retain the flag 104 on the attachment rod 122 and can be formed integral with the attachment rod 122, as shown in FIG. 1D, for example.

In some implementations, the flag 104 can be removable from the attachment rod 122. When the attachment rod 122 is attached to the bracket mechanism 121, the flag 104 can be removed from the attachment rod 122 by unscrewing, unclipping, or otherwise detaching the one or more clips 127 attached to each end of the attachment rod 122. The one or more clips 127 attached to each end of the attachment rod 122 can be removed in a manner in which they were attached. In response to removing the one or more of the clips 127 from one or more of the ends of the attachment rod 122, a designer or user can slide the flag 104 off the attachment rod 122. In some examples, the designer or user can replace the removed flag 104 with another flag or attach the previously removed clip 127 without replacing the removed flag 104. In implementations where the one or more clips 127 are formed integral with the attachment rod 122, such as the raised end portions 127 shown in FIG. 1D, the raised end portions 127 are sized such that they can allow for the flag 104 to be removed and replaced onto the attachment rod 122 by simply sliding the flag 104 onto the rod and off the rod for replacement, cleaning, or other purposes. But while in use, the raised end portions 127 assist in retaining the flag 104 on the attachment rod 122. In some examples, the flag 104 can also be made to be a permanent part of the device, e.g., the attachment rod 122.

In some implementations, the license plate 120 can be a floating attachment design that connects to the bracket mechanism 121. Specifically, by mounting the bracket mechanism 121 behind the license plate 120, a designer or user can easily replace the license plate 120 and cover it with a specialized license plate frame without interfering with the mounting of the license plate frame 106 shown in the system 105. Moreover, the bracket mechanism 121 can be utilized with any license plate that uses the four screw holes of the license plate, only the top two screw holes of the license plate, or only the bottom two-screw holes of the license plate. In this manner, the bracket mechanism 121 offers a benefit of flexibility in enabling attachment of any desired flag with a coupling of any desired specialized license plate or license plate frame and its corresponding attachment mechanism.

FIG. 1E is a block diagram that illustrates an example of a system 107 that includes various devices for coupling a flag 104 to a license plate 120 of a vehicle. The system 107 can include similar components, methods, and devices utilized in systems 100 through 105. Specifically, as illustrated in system 107, a vehicle can display a flag 104 on a particular portion of the vehicle. For example, the flag 104 can be attached behind the license plate 120 of the vehicle through various mechanisms and in various configurations. For example, the flag 104 can be retained by an attachment rod 122 that attaches to bracket mechanism 123, which connects behind the rear surface of license plate 120 and on-top of or directly to the license plate mounting surface of the vehicle.

In some implementations, the bracket mechanism 123 is similar to bracket mechanism 121. In some implementations, the bracket mechanism 123 is different from bracket mechanism 121. In the latter implementation, although the bracket mechanism 123 includes a first bracket 124 and a second bracket 128, similar to the bracket mechanism 121, the bracket mechanism 123 includes a component that enables releasable attachment of the attachment rod 122 to the bracket mechanism 123. Said another way, the attachment rod 122, which can retain the flag 104, can be releasably coupled, via, for example, a snap-fit coupling into and out of a set of retention mechanisms 132 of an attachment bracket component 130 of bracket mechanism 123. A designer or user can attach the attachment rod 122 to the retention mechanisms 132, and the retention mechanisms 132 can retain the attachment rod 122. The retention mechanisms 132 can retain the attachment rod 122 with sufficient grip, such that an ample amount of force is require to remove the attachment rod 122 from the retention mechanism 132. The ample amount of force can be a large enough in magnitude that movements of the vehicle 102 does not jar the attachment rod 122 loose from the retention mechanisms 132.

In some implementations, the retention mechanisms 132 can be configured to receive a shape of the attachment rod 122. For example, if the attachment rod 122 has a cylindrical shape, then the retention mechanisms 132 can include a fully-cylindrical or a half-cylindrical shape cavity. In some examples, the retention mechanisms 132 can include a quarter-shape cavity. The retention mechanisms 132 can include one or more components that cover or partially cover an outer portion of the attachment rod 122 upon the attachment rod 122 being received within the retention mechanisms 132. In this manner, covering or partially covering an outer portion of the attachment rod 122 and the shape of the retention mechanisms 132 can retain the attachment rod 122 in place.

In some implementations, the bracket mechanism 123 can be placed in a vertical configuration or a horizontal configuration as shown in FIG. 1E. In the vertical configuration, the flag 104 can drape in a vertical direction below the license plate 120. Moreover, the first bracket 124 and the second bracket 128 can align and mount to the license plate 120 screw holes in a vertical direction. In some examples, the first bracket 124 can mount to the leftmost vertical two screw holes 126 in a vertical manner or the rightmost vertical two screw holes 126 in a vertical manner. In some examples, the second bracket 128 can mount to the leftmost vertical two screw holes 126 in a vertical manner or the rightmost vertical two screw holes 126 in a vertical manner. In the horizontal configuration, the flag 104 can hang in a horizontal direction. The horizontal direction can include a direction to the left of the license plate or a direction to the right of the license plate. The first bracket 124 and the second bracket 128 can align and mount to the license plate 120 screw holes 126 in a horizontal direction. In some examples, the first bracket 124 can mount to the top two screw holes 126 in a horizontal manner or the bottom two-screw holes 126 in a horizontal manner. In some examples, the second bracket 128 can mount to the top two screw holes 126 in a horizontal manner or the bottom two-screw holes in a horizontal manner. The various configurations of the clips 127 as described and used in system 105 can also be utilized on the attachment rod 122 in system 107 on the opposite sides of each retention mechanism 132 in order to aid the rod in staying centered and the flag 104 kept in place as desired by the designer or user.

FIG. 1F is a block diagram that illustrates an example of a system 109 that includes various devices for coupling a flag 104 to a license plate 120 of a vehicle. The system 109 can include similar components, methods and devices utilized in systems 100 through 107. Specifically, as illustrated in system 109, a vehicle can display a flag 104 on a particular portion of the vehicle. For example, the flag 104 can be attached to the license plate of the vehicle through various mechanisms and in various configurations. For example, the flag 104 can be retained by an attachment rod 108 through an elongated opening 140 formed or defined in the attachment rod 108, which connects to a surface of a license plate or license plate frame 106. This diagram of system 109 is not limited to a rod that only has one attachment point and is open-ended—this is a cross-section of the device and is similar in shape to attachment rod 108 in that it stretches from one license plate mounting point 116 to another, and consists of two eyelets 110 which are located on opposing sides of said rod, or as potentially desired by the designer.

In some implementations, the attachment rod 108 can include a longitudinal slot 140 defined along a portion of the attachment rod 108 that is configured to receive a portion of the flag 104 to couple the flag 104 to the attachment rod 108. Specifically, the attachment rod 108 can include the longitudinal slot 140 that traverses a length of the attachment rod 108 and has a width of half a diameter of the attachment rod 108, for example. A user or designer of the attachment rod 108 can insert the flag 104 into the longitudinal slot 140 of the attachment rod 108 to secure the flag 104 to the attachment rod 108. In some examples, a width of the longitudinal slot 140 can be of different dimensions, e.g., 0.25 times the diameter of the attachment rod 108 or a different diameter.

System 109 illustrates different partial views of the attachment rod 108. In some examples, view 132 illustrates a top view of one of two identical sides of the attachment rod 108. View 134 illustrates a rear view of the attachment rod 108. View 136 illustrates a top view of the attachment rod 108 rotated 90 degrees from the view 132. View 138 illustrates a front view of the attachment rod 108. For example, as shown in view 138, the user of the attachment rod 108 can insert the flag 104 into the longitudinal slot 140 of the attachment rod 108 to secure the flag 104 to the attachment rod 108. The attachment rod 108 can secure the flag 104 in the longitudinal slot 140 via one or more mechanisms, or through passing the flag 104 through the slot and around the uppermost surface of the rod 108 in order to fuse, glue, stitch or otherwise attach the flag 104 around the system 109 and thereby to itself 104, rendering it a semi-permanent or permanent part of the device. The one or more mechanisms to retain the flag 104 can include, for example, grips, clips, internal force of the top and bottom components of the attachment rod 108, or another component or process such as heat bonding once the flag 104 is inserted into the slot of the system 109 during production by a designer. The one or more mechanisms can ensure the flag 104 remains in the longitudinal slot 140 in the attachment rod 108 and is not disrupted by external forces, e.g., wind, rain, movement of the vehicle or other forces due to mounting system to another suitable object that is not a vehicle.

In some implementations, the attachment rod 108 can be secured to a vehicle using any of the mechanisms described with respect to systems 100 through 107. The flag 104 can be secured to the attachment rod 108 via the longitudinal slot 140 prior to the attachment rod 108 attaching to the vehicle, such as through one or more screw holes of license plate, or after the attachment rod 108 has been securely attached to the vehicle. Similarly, in some implementations, the flag 104 can be replaced with other flags, banner, or messages while the attachment rod 108 is secured to the vehicle or when the attachment rod 108 is not secured to the vehicle, and in some implementations the flag 104 cannot be removed from the rod 108. In some implementations, instead of the slot 140 being defined in the attachment rod 108, a longitudinal slot can be formed along a portion of the license plate frame 106 such that a user could slide the flag 104 into the slot so as to retain the flag 104 with respect to the license plate frame 106.

In some implementations, the attachment rod 108 with slot and self-contained flag as represented in system 109 can be made a permanent fixture of the license plate frame 106 or made integral with the license plate frame 106. The permanent fixture can be, for example, the attachment rod 108 from system 109 embedded within a bottom portion or side portion of the license plate frame 106. In this manner, the attachment rod 108 from system 109, the license plate frame 106, and a corresponding flag 104 can be provided as a single device or assembly of components.

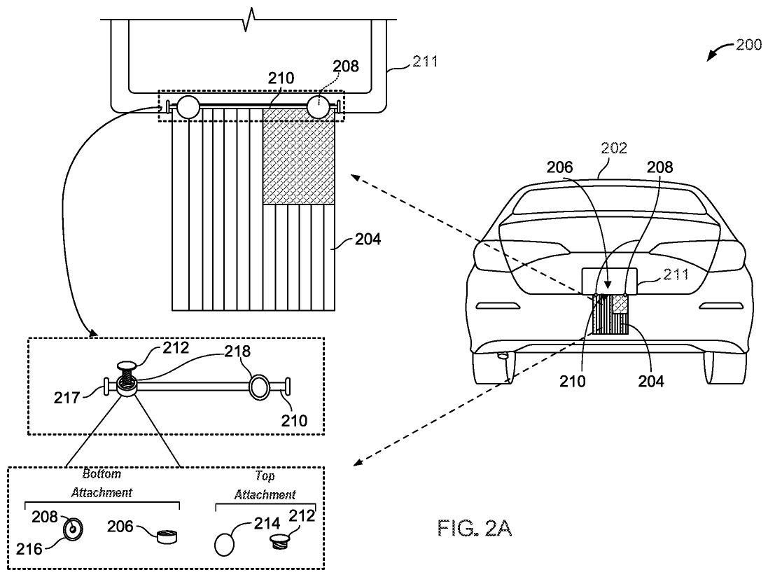

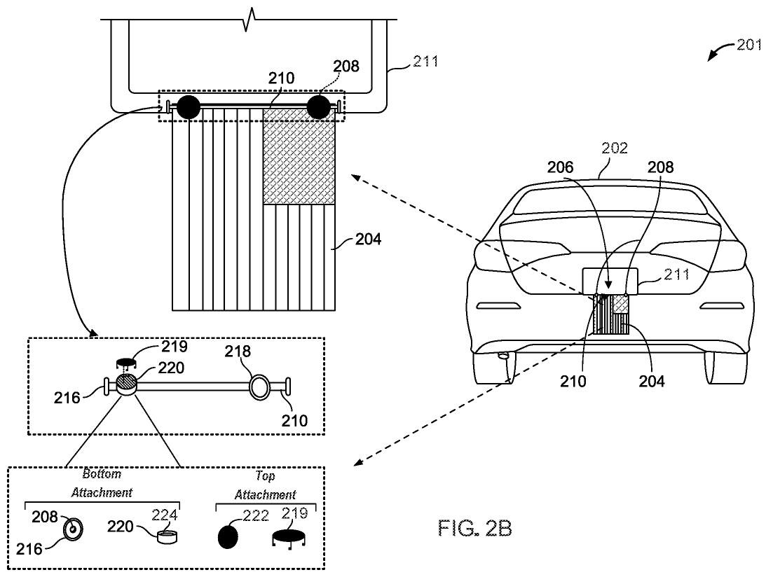

FIG. 2A is a block diagram that illustrates an example of a system 200 that includes various retention devices for coupling a flag to a license plate 211 or license plate frame 106 of a vehicle. In some implementations, the system 200 can include various components and devices that can attach any type of communication component to a particular object to be displayed to a desired audience. The systems, methods, and components described with respect to systems 100 through 109 can also be incorporated in system 200. Specifically, as illustrated in system 200, a vehicle 202 can display a flag 204 on a particular portion of the vehicle 202. The flag 204 can be attached to a license plate 211 or license plate frame 106 of the vehicle 202 through various mechanisms and in various configurations. For example, and as will be described below, the flag 204 can be retained by a retention device that adjoins to a front surface of license plate 211 or license plate frame 106.

In some implementations, the retention device 206 can be created from a variety of materials and can be of any shape or desired size. Specifically, the retention device 206 can be created from one or more of plastic, metal, wood, rubber, graphic, metal composite, carbon block, fiberglass, or any other suitable material. The retention device 206 can additionally be created from, for example, a hybrid material set combining at least one of plastic, metal, wood, rubber, or some other combination. The retention device 206 can utilize one or more existing license plate screws 111 to attach to a vehicle. In some examples, the retention device 206 can adjoin to the license plate 211 or license plate frame 106 using other attachment components, such as a different screw, a nail, bolt, adhesive, or another suitable fastening device. The retention device 206 can also mount to any vehicle or any non-movable object, such as any car, truck, trailer, boat, motorcycle, SUV, bus, golf cart, ATV, dune buggy, motor home, construction machinery, wave-runner, tractor, plane, helicopter, a wall, a truck bumper, a fence, window, a pipe, or any other kind of object. The retention device 206 can attach to one or more of these objects to directly attach and retain a flag, a banner, a brand, a logo, or other, such as the flag 204 illustrated in system 200 of FIG. 2A.

In some implementations, the flag 204 can be similar to flag 104. The flag 204 can be created from plastic, cotton, nylon fabric, or any other type of suitable material. The flag 204 can be retained on an attachment rod 210. In some examples, the attachment rod 210 can include a dowel rod, a non-retained grommeted flag, a non-retained eyeleted flag, a non-retained grommeted/eyeleted banner/brand logo, or a retained flag 104, to name a few examples. In some implementations, the attachment rod 210 can retain the flag 204 by way of securing one or more fasteners 212 to its eyelets 218 or grommets to the retention device 206, or by similar flag 104 attachment rod 108 in systems 100-109. Specifically, a designer or user can secure the attachment rod 210 to the retention device 206 with a fastener 212 by screwing one or more license plate screws 111 into the eyelets 208. Prior to securing the attachment rod 210 to the retention device 206, the designer can slide a flag onto the attachment rod 210, or wrap the rod with a flag 204 and attach it semi-permanently or permanently through adhesion, heat fusing, sewing, or similar method to the rod 210. The screwing or unscrewing of one or more fasteners 212 into the eyelets 218 of the rod 210 into the retention device 206 allows for easy removal and changing of the rod 210 and/or flag 204 with other flags 204 or other rods 210 or other similar type objects. In this manner, the attachment rod 210 and the retained flag 204 can be easily removed and replaced without removing the base retention device 206 since it is semi-permanently adjoined to the license plate 211 or license plate frame 106 through the use of license plate screws 111, or similar.

In some implementations, the base retention device 206 can be retained to an object or vehicle by various methods. Specifically, the screws 111 of the license plate 211 or license plate frame 106, other screws, nails, bolts, zip ties, hook and loop fastener, or other attachment components can retain the base of the retention device 206 for the rod 210 in system 200. The threading found in system 200 on the base retention device 206 and the fastener top 212 could be inverted between being on the inside of the base retention device cavity 206 and wall 216 to the outside of the base retention device 206 and wall 216, and from the outside wall of the fastener top 212 to the inside cavity of fastener 212, as desired by the designer.

A distance between each of the retention devices 206 on the attachment rod 210 can be, for example, 7.5 inches or another distance. A distance between a center of each of the retention devices 206 on the attachment rod 210 can be, for example, 7 inches or another distance. A length of flag 204 can be, for example, 9.75 inches or another length. A width of flag 204 can be, for example, 8.5 inches or another width.

In some implementations, the attachment rod 210 can be similar to attachment rod 108. Specifically, the attachment rod 210 can be created from one or more materials. For example, the attachment rod 210 can be created from plastic, metal, wood, rubber, graphite, metal composite, carbon black, fiberglass, or of any other suitable or desirable material, such as a hybrid or combination of plastic, metal, wood, rubber, or some other combination of materials. In some examples, a length of the pole rod 210 can vary according to designer preferences. The length of the attachment rod 210 can vary between a width of the mounting points of the retention device 206 or to extend beyond and be wider than the distance of the mounting points of the retention device 206 with clips 127 at the ends of the rod to keep the flag 204 in place. The mounting points of the retention device 206 can include locations of the license plate screw holes 208, for example.

In use, the retention device 206 may be first adjoined to the license plate 211 or license plate frame 106 by using, for example, the license plate mounting screw. The attachment rod 210 can be formed with a cutout to accommodate the size and shape of the attachment device 206 and fastener 212 within a portion or portions of the attachment rod 210. Once two of the retention devices 206 are adjoined to the license plate 211 or license plate frame 106, then the user can place the attached rod 210 onto the attachment device 206. Then the user can place and screw in the two top attachment elements 212 into respective retention device or devices 206, via for example a snap fit arrangement or screws as described in FIG. 2B, to complete the adjoining of the attachment rod 210 to the license plate 211 or license plate frame 106. The attachment rod 210 can be placed in a horizontal or vertical mounting position along the license plate 211 according to specific user requirements. Moreover, a design of the retention device 206, the top attachment elements 212, and the attachment rod 210 can be scaled to be exponentially larger or smaller, depending on a desired application, as well as in different shapes, as required by designer.

A diameter of the base of the retention device 206 can be, for example, 1 inch or a different diameter. A diameter of the eyelets 208 can be, for example, 0.28125 inches or another diameter. A wall 216 of the retention device 206 that surrounds the base can be, for example, 0.125 inches thick or a different thickness. A height of the wall that surrounds the base 206 can be, for example, 0.375 inches or a different height. A diameter of the fastener 212 can be, for example, 1.1 inches or a different diameter. A diameter of the threaded portion of the fastener 212 can be, for example, 0.75 inches or a different diameter. A height of the license plate screws 212 can be, for example, 1.25 inches or a different height. A thickness of a ring around the hole 218 can include, for example, 0.125 inches or a different thickness. Similar dimensions exists for the components shown in system 201.

In some implementations, the retention device(s) 206 can be a permanent fixture of the license plate frame 106 or made integral with the license plate frame 106. The permanent fixture can be, for example, the retention device(s) 206 embedded within a bottom portion or side portion of the license plate frame 106. In this manner, the retention device(s) 206, the license plate frame 106, the fastener 212, and a corresponding flag 104 and rod 210 can be provided as a single device or assembly of components.

FIG. 2B is a block diagram that illustrates an example of a system 201 that includes various retention devices 220 for coupling a flag 204 to a license plate 211 or license plate frame 106 of a vehicle. In some implementations, the system 201 can include various components and devices that can attach any type of communication component to a particular object to be displayed to a desired audience. The systems, methods, and components described with respect to system 200 can also be incorporated in system 201. Specifically, as illustrated in system 201, a vehicle 202 can display a flag 204 on a particular portion of the vehicle 202. The flag 204 can be adjoined to a license plate 211 or license plate frame 106 of the vehicle 202 through various mechanisms and in various configurations. For example, and as will be described below, the flag 204 can be retained by a retention device 220 that adjoins to the front surface of license plate 211 or to a license plate frame 106.

In some implementations, the system 201 can include similar components to system 200. In this case the similarly described components will not be described again. System 201 can include a retention device 220 that is different from the retention device 206 utilized in system 200. The retention device 220 can be, for example, a snap fit retention device. The retention device 220 can include a device that snaps closed to retain a flag 204 on the attachment rod 210. Specifically, the retention device 220 includes a snap connector 219 with four prongs that distend into the retention device 220, and snaps into a ring 224 within the retention device 220. A designer or user can press on the top cap 222 of the snap connector 219 to snap the snap connector 219 into the retention device 220. The snapping of the snap connector 219 into the ring 224 within the retention device 220 secures the rod 210 and flag 204 connector systems 201 to the desired mounting surface, whether license plate 211, license plate frame 106, or other object or vehicle.

In some examples, a number and size of the prongs on the snap connector 218 that connects to the retention device 220 can be increased or decreased, depending on user criteria. For example, a number or size of the prongs on the snap connector 219 can increase to increase the strength of the connection between the snap connector 219 and the retention device 220. Similarly, a number or size of the prongs on the snap connector 219 can decrease to decrease the strength of the connection between the snap connector 219 and the retention device 220. In some implementations, the retention device(s) 220 can be a permanent fixture of the license plate frame 106 or made integral with the license plate frame 106. The permanent fixture can be, for example, the retention device(s) 220 embedded within a bottom portion or side portion of the license plate frame 106. In this manner, the retention device(s) 220, the license plate frame 106, the snap connector 219, and a corresponding flag 104 and rod 210 can be provided as a single device or assembly of components.

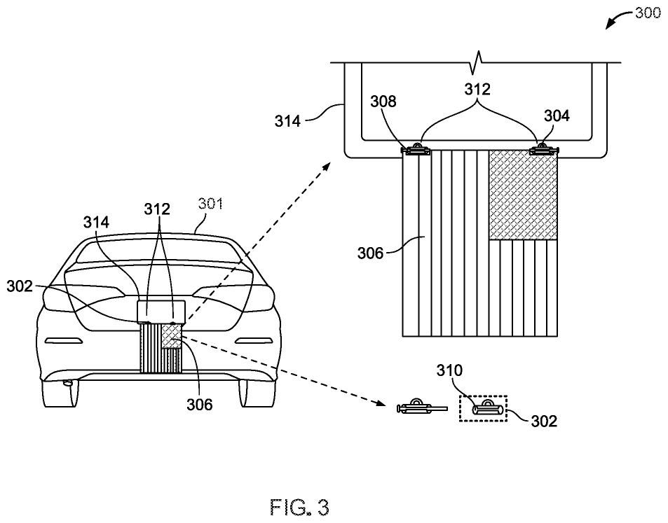

FIG. 3 a block diagram that illustrates an example of a system 300 that includes various retention devices for coupling a flag 306 to a license plate 314 or license plate frame 106 of a vehicle 301. In some implementations, the system 300 can include various components and devices that can attach any type of communication component to a particular object to be displayed to a desired audience. The systems, methods, and components described with respect to systems 200 and 201 can also be incorporated in system 300. Specifically, as illustrated in system 300, a vehicle 301 can display a flag 306 on a particular portion of the vehicle 301. For example, the flag 306 can be attached to a license plate 314 of the vehicle 301 through various mechanisms and in various configurations. For example, and as will be described below, the flag 306 can be retained by one or more retention devices 302 that connect to a surface of license plate 314 or license plate frame 106, or other surface of the vehicle 301.

In some implementations, the retention device 302 can be created from a variety of materials and can be of any shape or desired size. Specifically, the retention device 302 can be created from plastic, metal, wood, rubber, graphite, metal composite, carbon black, fiberglass, or any other suitable material. The retention device 302 can additionally be created from, for example, a hybrid material set combining at least one of plastic, metal, wood, rubber, or some other combination. The retention device 302 can utilize one or more existing license plate screws 304 to attach to vehicle 301. In some examples, the retention device 302 can attach to the license plate 314 using other attachment components, such as a different screw, a nail, a bolt, hook and loop fastener, glue, adhesive, or another fastening device. The retention device 302 can also mount to any vehicle or any non-movable object, such as any car, truck, trailer, boat, motorcycle, SUV, bus, golf cart, ATV, dune buggy, motor home, construction machinery, wave-runner, tractor, plane, helicopter, a wall, a trailer, a truck bumper, a pipe, or any other kind of object. The retention device 302 can attach to one or more of these objects to directly attach and retain a flag, a banner, a brand, a logo, or other, such as the flag 306 illustrated in system 300.

In some implementations, the flag 306 can be similar to flag 204. The flag 306 can be created from plastic, cotton, nylon fabric, or any other type of suitable material. The flag 306 can be retained on pole rod 308. In some examples, the attachment rod 308 can include a dowel rod or another type of rod that can retain a flag. The attachment rod 308 can be created from, for example, plastic, metal, wood, rubber, graphite, metal composite, carbon black, fiber-glass, or of any other suitable or desirable material, such as a hybrid or combination of plastic, metal, wood, rubber, or some other combination of materials.

In some implementations, the attachment rod 308 can be used to hold a flag 306 in a desired position on the vehicle. The attachment rod 308 with the retained flag 306 can be releasably coupled in a retention slot 310 of a corresponding retention device 302. A designer or user can press the attachment rod 308 and retained flag 306 into the retention slot 310 of the retention device 302, where the retention device 302 can hold and releasably retain the attachment rod 308 and flag 306. In this example, the attachment rod 308 and flag 306 can be easily removed and replaced without removing the retention device 302 from its attached location. For example, the attached location can include a location of a license plate screw hole 304.

A length of the retention device 302 can be, for example, 1 inch or a different length. A height of a screw hole on the retention device 302 can be, for example, 0.25 inches or a different height. A width of a screw hole on the retention device 302 can be, for example, 0.3 inches or a different width.

As mentioned, each retention device 302 can be retained by a license plate screw at the license plate screw hole 304. In some examples, each retention device 302 can be retained by other attachment components, such as other screws, nails, bolts, zip ties, adhesives, hook and loop fastener, and other devices. In some examples, a length of the attachment rod 308 can vary according to user preferences or vehicular dimensions. Specifically, the length of the attachment rod 308 can vary between a width of the mounting points 312 of each retention device or to extend beyond and be wider than the distance of the mounting points 312 of each retention device 302. The mounting points 312 of the retention device 302 can include locations of the license plate screw holes, for example.

Moreover, the attachment rod 308 can placed in a horizontal or vertical mounting position along the license plate 314 according to specific user requirements. Moreover, a design of the retention device 302 and the attachment rod 308 can be scaled to be exponentially larger or smaller, depending on a desired application. In an event that the attachment rod 308 is placed in a vertical mounting position along the license plate 314, a designer or user can rotate each of the retention device 302's by 90 degrees to support the vertical mounting of the attachment rod 308 in each of the retention devices 302. The retention devices 302 can also be formed to rotate about a central axis of the retention device 302 in order to accommodate vertical, horizontal, angled, or other suitable mounting of the pole rod 308 on the license plate 314 of vehicle 301. In some implementations, the retention device(s) 302 can be a permanent fixture of the license plate frame 106 or made integral with the license plate frame 106. The permanent fixture can be, for example, the retention device(s) 302 embedded within a bottom portion or side portion of the license plate frame 106. In this manner, the retention device(s) 302, the license plate frame 106, and a corresponding flag 306 and rod 308 can be provided as a single device or assembly of components.

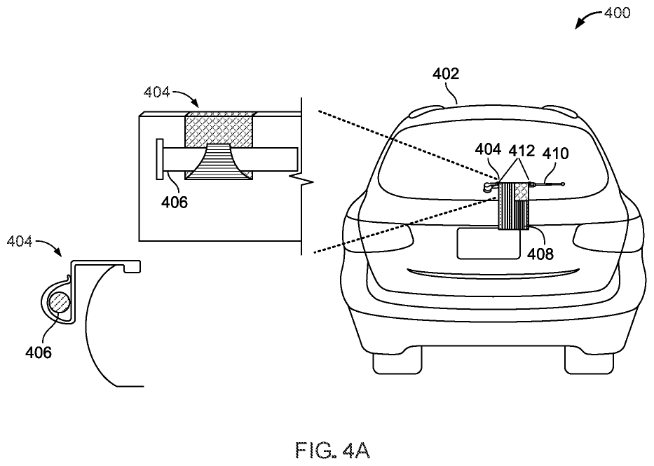

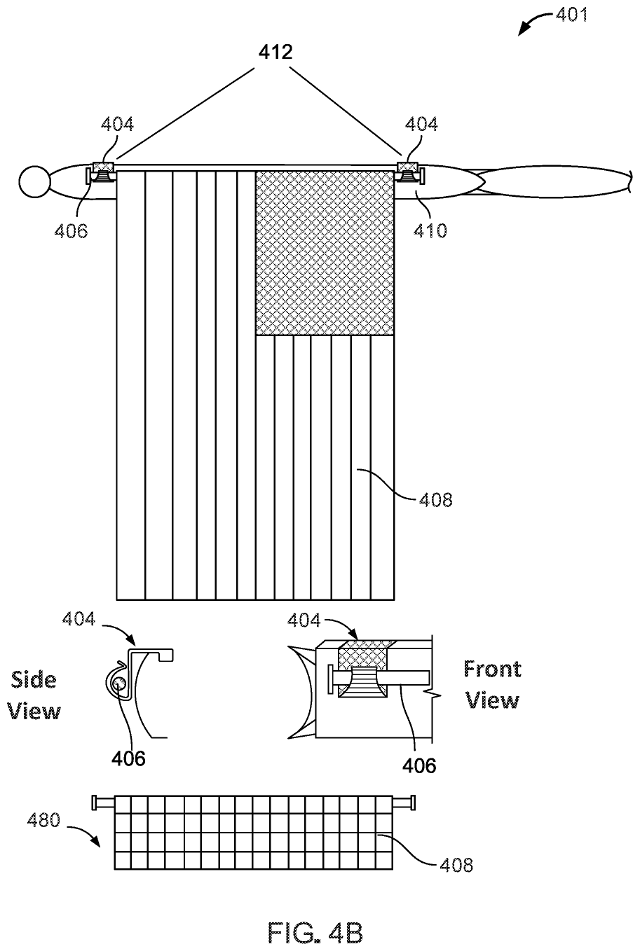

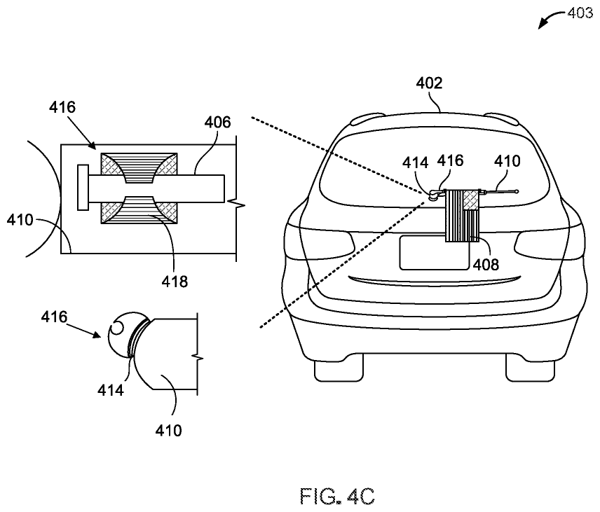

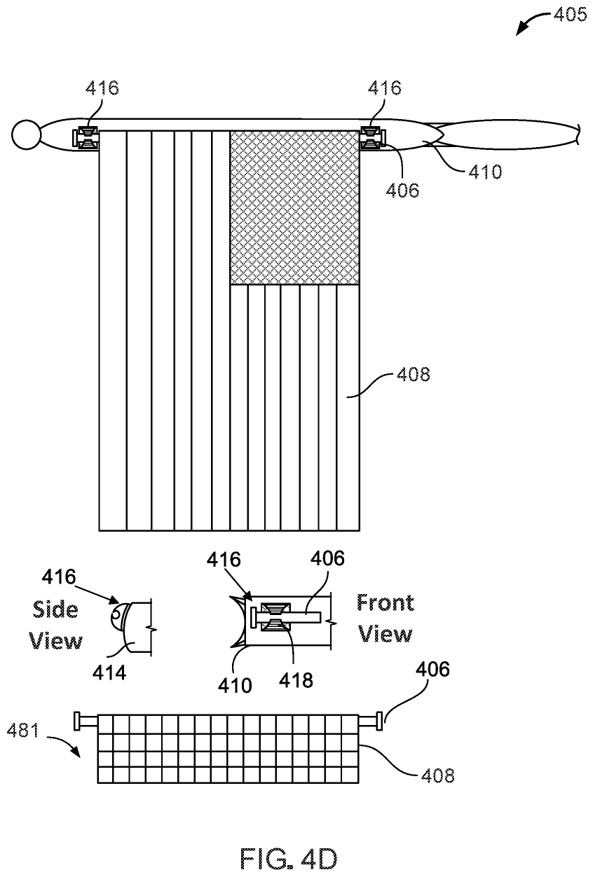

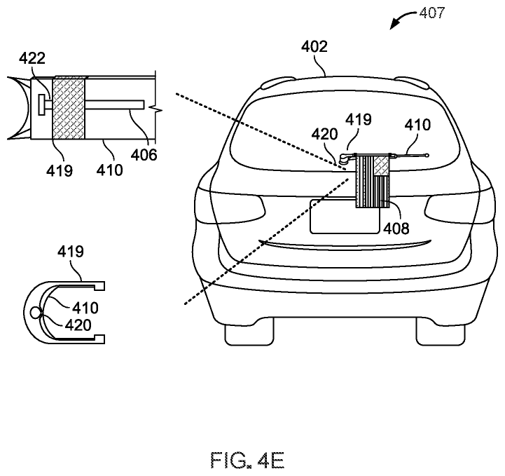

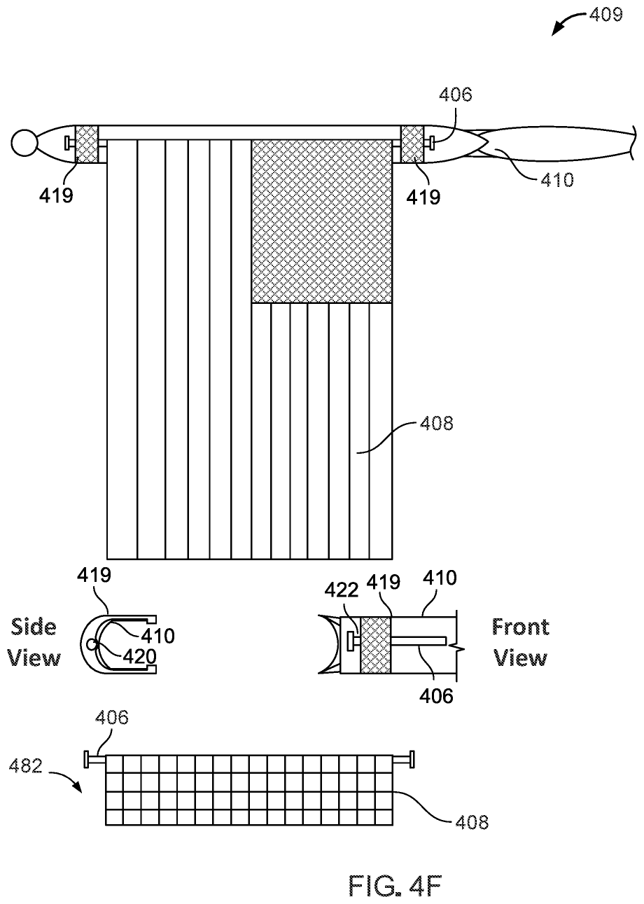

FIG. 4A is a block diagram that illustrates an example of a system 400 that includes various devices for coupling a flag to another location of a vehicle, such a rear windshield wiper of a vehicle. As illustrated in system 400 of FIG. 4A, a vehicle 402 can display a flag 408 on a particular portion of the vehicle. Specifically, the flag 408 can be attached to a rear windshield wiper blade 410 through various mechanisms and in various configurations. For example, and as will be described below, the flag 408 can be retained by an attachment rod 406 supported by two or more retaining clips 404 attached to the rear windshield wiper blade 410.

In some implementations, the two or more retaining clips 404 can be created from a variety of materials and can be of any shape or desired size. Specifically, the two or more retaining clips 404 can be created from one or more of plastic, metal, wood, rubber, graphic, metal composite, carbon block, fiberglass, or any other suitable material. The two or more retaining clips 404 can additionally be created from, for example, a hybrid material set combining at least one of plastic, metal, wood, rubber, or some other combination.

In some implementations, the two or more retaining clips 404 can retain an attachment rod 406 and associated flag 408. In some examples, the two or more retaining clips 404 can attach to one or more windshield wiper blades of vehicle 402. Similarly, the two or more retaining clips 404 can attach to one or more windshield wiper blades of any vehicle including, but not limited to, a car, truck, trailer, boat, motorcycle, SUV, bus, golf cart, ATV, dune buggy, motor home, construction machinery, wave-runner, tractor, plane, helicopter, a wall, a trailer, a truck bumper, a pipe, or any other kind of object. Similarly, the two or more retaining clips 404 can attach to one or more devices, objects, surfaces, or other stationary objects, such as a gutter on a house, a window ledge, a window, a fence, a window housing, a patio surface, a deck surface, a kitchen countertop surface, or another surface.

In some implementations, the flag 408 can be similar to flag 104. Specifically, the flag 408 can be created from plastic, cotton, nylon fabric, or any other type of suitable material. The flag 408 can be retained on an attachment rod 406. Once the attachment rod 406 is passed through an elongated opening formed in the flag 408, the attachment rod 406 can be disposed, for example, via a snap fit arrangement, into each of the retaining clips 404. The retaining clips 404 can include, for example, a D-shaped portion, a C-shaped portion, a U-shaped portion, or another shape that can assist in retaining and holding the attachment rod 406 and associated flag 408 in a desired location. The retaining clips 404 can also include a rear-shaped portion formed opposite the D-shaped portion that assists in cooperating with the windshield wiper blade housing to releasably attach the retaining clips 404 to the wiper blade housing. Moreover, the retaining clips 404 can retain the attachment rod 406 and flag 408 when (i) the windshield wiper blade 410 moves across the windshield of the vehicle 402 and (ii) as the vehicle 402 traverses down a roadway.

In some implementations, the attachment rod 406 can be similar to attachment rod 308. Specifically, the attachment rod 406 can be created from one or more materials. For example, the attachment rod 406 can be created from plastic, metal, wood, rubber, graphite, metal composite, carbon black, fiberglass, or of any other suitable or desirable material, such as a hybrid or combination of plastic, metal, wood, rubber, or some other combination of materials. In some examples, a length of the attachment rod 406 can vary according to application or user preferences. The length of the attachment rod 406 can vary between a width of the mounting points 412 of the retaining clips 404 or to extend beyond and be wider than the distance of the mounting points 412 of the retaining clips 404.

In some implementations, the location of the mounting points 412 of the retaining clips 404 can be adjusted. For example, the location of the left-most retaining clip 404 can be moved to the center of the attachment rod 406 and the location of the right-most retaining clip 404 can be moved to the center of the attachment rod 406. Similarly, the locations of both the retaining clips 404 can be extended to each end of the attachment rod 406. The location of the mounting points 412 of the retaining clips 404 can be adjusted to any location depending on a designer's or user's criteria.

FIG. 4B is a block diagram that illustrates an example of a system 401 that includes various devices for coupling a flag to a windshield wiper of a vehicle. System 401 illustrates a zoomed in version of the components shown in system 400 of FIG. 4A. Specifically, an attachment rod 406 retains the flag 408. Two retaining clips 404 retain the attachment rod 406 and associated flag 408. The two retaining clips 404 can be mounted on a windshield wiper blade 410 of a vehicle at the mounting point locations 412. Moreover, the component 480 illustrates the attachment rod 406 passing through the elongated opening of the flag 408. After the attachment rod 406 is passed through the elongated opening of the flag 408, a designer or user of system 401 can insert the attachment rod 406 into the D-shaped opening of the two retaining clips 404.

As shown in the side view, a height of the attachment rod 406 can be, for example, 0.25 inches or a different height. A height of the D-shape portion of the two retaining clips 404 can be, for example, 0.375 inches, or a different height. A length of the D-shape clip of the two retaining clips 404 can be, for example, 0.5 inches or a different length. A height of the retaining clip 404 can be, for example, 0.5 inches or a different height. As shown in the front view, a width of an end of the pole rod 406 can be, for example, 0.125 inches or a different width. A height of an end of the pole rod 406 can be, for example, 0.3125 inches or a different height. A width of the retaining clip 404 on the windshield wiper blade 410 can be, for example, 0.5 inches or a different width.

FIG. 4C is a block diagram that illustrates an example of a system 403 that includes various devices for coupling a flag to a windshield wiper of a vehicle. As illustrated in system 403, a vehicle 402 can display a flag 408 on a particular portion of the vehicle. Specifically, the flag 408 can be attached to a windshield wiper blade 410 through various mechanisms and in various configurations. For example, and as will be described below, the flag 408 can be retained by an attachment rod 406 supported by two or more retaining brackets 416 with retention slots 418 on the windshield wiper blade 410.

In some implementations, the retaining brackets 416 can be created from a variety of materials and can be of any shape or desired size. Specifically, the retaining brackets 416 can be created from one or more of plastic, metal, wood, rubber, graphic, metal composite, carbon block, fiberglass, or any other suitable material. The retaining brackets 416 can additionally be created from, for example, a hybrid material set combining at least one of plastic, metal, wood, rubber, or some other combination.

In some implementations, the retaining brackets 416 can retain an attachment rod 406 that retains a flag 408 with retention slots 418 on the windshield wiper blade 410. In some examples, the retaining brackets 416 can attach to one or more windshield wiper blades 410 of vehicle 402. Similarly, the retaining brackets 416 can attach to one or more windshield wiper blades, windows, or any other exterior or interior surface of any vehicle including, but not limited to, a car, truck, trailer, boat, motorcycle, SUV, bus, golf cart, ATV, dune buggy, motor home, construction machinery, wave-runner, tractor, plane, helicopter, a wall, a trailer, a truck bumper, a pipe, or any other kind of object. Similarly, the retaining brackets 416 can attach to one or more device, object, surface, or other stationary object, such as a gutter on a house, a window ledge, a fence, a window, a wall, a locker, a cabinet, rafters in a ceiling, a window housing, a patio surface, a deck surface, a kitchen countertop surface, or another surface.

In some implementations, the flag 408 can be retained on an attachment rod 406. Once the attachment rod 406 is passed through the elongated opening of the flag 408, or adhered, sewn or heat-fused, or otherwise adhered to the attachment rod 406, the attachment rod 406 with the flag 408 can be snapped into each of the retention slots 418 of the retaining brackets 416. In this example, the attachment rod 406 and flag 408 can thus be easily removed and replaced without removing the retaining brackets 416 from their mounting point locations on the windshield wiper blade 410.

In some examples, the retaining brackets 416 can couple to an adhesive backing 414, a magnet, a suction cup, or another adhesion method. The adhesive backing 414 or other adhesion methods can attach to the windshield wiper blade 410 or other surface, and secure the retaining brackets 416 in place. Moreover, the adhesive backing 414 can secure the retaining brackets 416 during their coupling with the attachment rod 406 and the flag 408. The retaining brackets 416 can retain the attachment rod 406 with the flag 408 when (i) the windshield wiper blade 410 moves across the windshield of the vehicle 402 and (ii) as the vehicle 402 traverses down a roadway. In some examples, a shape and size of the retaining brackets 416 can be scaled to be exponentially larger or smaller, depending on the desired application or criteria, and with more or less retaining brackets 416. For example, the system 403 can utilize three retaining brackets 416 attached to the windshield wiper blade 410 to improve a grip with which each of the retaining brackets 416 secures to the attachment rod 406, with varying methods of adhesion.

In some implementations, the attachment rod 406 with the flag 408 can snap into the retention slots 418 of the retaining bracket 416 on the windshield wiper blade 410. In some examples, the retaining bracket 416 with the retention slots 418 can be attached or coupled to other surfaces, such as a stationary surface or other movable surfaces. In some examples, the retaining bracket 416 with the retention slots 418 can be attached or coupled by mechanisms different from the adhesive backing. For example, the retaining bracket 416 with the retention slots 418 can be attached or coupled by using one or more screws, tape, rope, bolts, glue, hook and loop fasteners, and other attachment components that cause two objects to retain contact with one another.

A width of the retention slot 418 can be, for example, 0.25 inches or another width. A width of the retaining bracket 416 can be, for example, 0.5 inches or another width. A width of an adhesive 414 between the retaining bracket 416 and the windshield wiper blade 410 can be, for example, 0.125 inches or another width. A width of a portion of the retaining bracket 416 that retains the pole rod 406 can be, for example, 0.25 inches or another width. In some implementations, the retaining bracket(s) 416 can be a permanent fixture of the windshield wiper blade housing/cover 410 or a license plate frame 106, or made integral with the windshield wiper blade 410 or a license plate frame 106. The permanent fixture can be, for example, the retaining bracket(s) 416 embedded within a bottom, top, or side portion of the windshield wiper blade housing/cover 410, or a license plate frame 106. In this manner, the retaining bracket(s) 416, the windshield wiper blade housing/cover 410 or the license plate frame 106, and a corresponding flag 408 and rod 406, can be provided as a single device or assembly of components.

FIG. 4D is a block diagram that illustrates an example of a system 405 that includes various devices for coupling a flag to a windshield wiper of a vehicle. System 405 illustrates a zoomed in version of the components shown in system 403. Specifically, an attachment rod 406 retains the flag 408. The attachment rod 406 is retained by the retention slots 418 in the corresponding retaining brackets 416. The two retaining brackets 416 can be mounted on a windshield wiper blade 410 of a vehicle using adhesive backing 414 or another type of coupling mechanism. Moreover, the component 481 illustrates the attachment rod 406 adhered to, sewn to, or heat-bonded to, or passing through the elongated opening of the flag 408. After the attachment rod 406 has passed through the elongated opening of the flag 408, a designer or user of system 405 can insert the attachment rod 406 into the retention slots 418 of the two retaining brackets 416.

A length of the attachment rod 406 from end to end can be, for example, 9.25 inches or another length. A height of the flag 408 can be, for example, 12.25 inches or another height. A width of the flag 408 can be, for example, 8 inches or another width.

FIG. 4E is a block diagram that illustrates an example of a system 407 that includes various devices for coupling a flag to a windshield wiper of a vehicle. As illustrated in system 407, a vehicle 402 can display a flag 408 on a particular portion of the vehicle. Specifically, the flag 408 can be attached to a windshield wiper blade 410 through various mechanisms and in various configurations. For example, and as will be described below, the flag 408 can be retained by an attachment rod 406 supported by two or more clamp brackets 419 with retention slots 420 onto the windshield wiper blade 410.

In some implementations, the clamp brackets 419 can be created from a variety of materials and can be of any shape or desired size. Specifically, the clamp brackets 419 can be created from one or more of plastic, metal, wood, rubber, graphic, metal composite, carbon block, fiberglass, or any other suitable material. The clamp brackets 419 can additionally be created from, for example, a hybrid material set combining at least one of plastic, metal, wood, rubber, or some other combination.

In some implementations, the clamp brackets 419 can retain an attachment rod 406 that retains a flag 408 with retention slots 420 on the windshield wiper blade 410. In some examples, the clamp brackets 419 can attach to one or more windshield wiper blades 410 of vehicle 402. Specifically, the clamp brackets 419 can squeeze, grip, hold, claw, or clamp on the one or more windshield wiper blade 410 of vehicle 402 for attachment. A designer or user of system 407 can attach the clamp brackets 419 to the windshield wiper blade 410 at the end locations 422 of the attachment rods 406. In some examples, the clamp brackets 419 can attach to the windshield wiper blade 410 at other locations along a portion of the windshield wiper blade 410.

Similarly, the clamp brackets 419 can attach to one or more windshield wiper blades of any vehicle including, but not limited to, a car, truck, trailer, boat, motorcycle, SUV, bus, golf cart, ATV, dune buggy, motor home, construction machinery, wave-runner, tractor, plane, helicopter, a wall, a trailer, a truck bumper, a pipe, or any other kind of object. Similarly, the retaining brackets 416 can attach to one or more devices, object, surface, or other stationary object, such as a gutter on a house, a window ledge, a fence, a window or windshield housing, a patio surface, a deck surface, a kitchen countertop surface, or another surface that the clamp brackets 419 can hold onto.

In some implementations, the flag 408 can be retained on an attachment rod 406. Once the attachment rod 406 is passed through an elongated opening formed in the flag 408, the attachment rod 406 with the flag 408 can be attached, i.e., clamped, to the windshield wiper blade 410 with the clamp brackets 419. Specifically, the attachment rod 406 with the flag 408 can be snapped into the retention slots 420 of the clamp brackets 419. In response to snapping the attachment rod 406 with the retained flag 408 into the retention slots 420 of the clamp brackets 419, a designer or user can attach the clamp bracket 419 with the attachment rod 406 and retained flag 408 by clamping the clamp bracket 419 to the windshield wiper blade 410, for example. The clamp bracket 419 can be attached to the windshield wiper blade 410 using other attachment mechanisms as well. By attaching the clamp bracket 419 to the windshield wiper blade 410 while the clamp bracket 419 retains the attachment rod 406 with the retained flag 408, the clamp bracket 419 can secure the attachment rod 406 with the retained flag 408 when (i) the windshield wiper blade 410 moves across the windshield of the vehicle 402 and (ii) as the vehicle 402 traverses down a roadway.

In some implementations, the clamp bracket 419 can be removed from the windshield wiper blade 410 before replacing the attachment rod 406 and the retained flag 408. For example, should a designer or user of system 107 desire to replace the retained flag 408 on the attachment rod 406 with a different flag, banner, or other, the clamp bracket 419 can be removed first from the windshield wiper blade 410 to enable access to the attachment rod 406 snapped into the retention slots 420. Once enabled access, the designer or user can unsnap or detach the attachment rod 406 with the retained flag 408 from the retention slots 420. Here, the designer can replace the retained flag 408 on the attachment rod 406 with a different flag, banner, or other communication component. Afterwards, the designer or user can attach the attachment rod 406 with the replaced flag into the retention slots 420 of the clamp bracket 419, and attach the clamp bracket 419 to the windshield wiper blade 410 for use on the vehicle 402.

In some examples, a length of the attachment rod 406 can vary according to customer preferences. The length of the attachment rod 406 can vary between a width of the locations of the clamp brackets 419 on the windshield wiper blade 410 or to extend beyond and be wider than the distance between the locations of the clamp brackets 419 on the windshield wiper blade 410. As such, a length of the attachment rod 406 can be resized or adjusted in different orientations according to customer preferences.

A width of the clamp bracket 419 can be, for example, 0.5 inches or a different width. A height of the clamp bracket 419 can be, for example, 1 inch. A width of the retention slots 420 can be, for example, 0.25 inches or a different width. A distance between a starting point of the retention slot 420 and an end point of the clamp bracket 419 can be, for example, 0.625 inches or a different distance. A length of the clamp bracket 419 can be, for example, 1.125 inches or a different length.

FIG. 4F is a block diagram that illustrates an example of a system 409 that includes various devices for coupling a flag to a windshield wiper of a vehicle. System 409 illustrates a zoomed in version of the components shown in system 407. Specifically, an attachment rod 406 retains the flag 408. The attachment rod 406 is retained by the retention slots 420 in the corresponding clamp brackets 419. The two clamp brackets 419 can be attached to a windshield wiper blade 410 of a vehicle by clamping or another type of coupling mechanism. Moreover, the component 481 illustrates the attachment rod 406 passing through the elongated opening formed in the flag 408. After the attachment rod 406 has passed through the elongated opening of the flag 408, a designer or user of system 409 can attach the attachment rod 406 into the retention slots 420 of the corresponding clamp brackets 419, which can be subsequently attached to the windshield wiper blade 410.

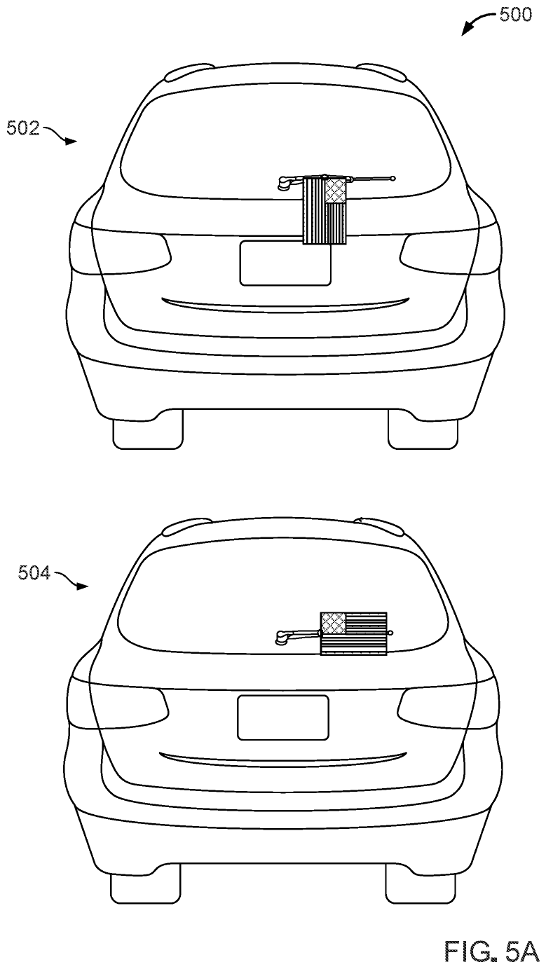

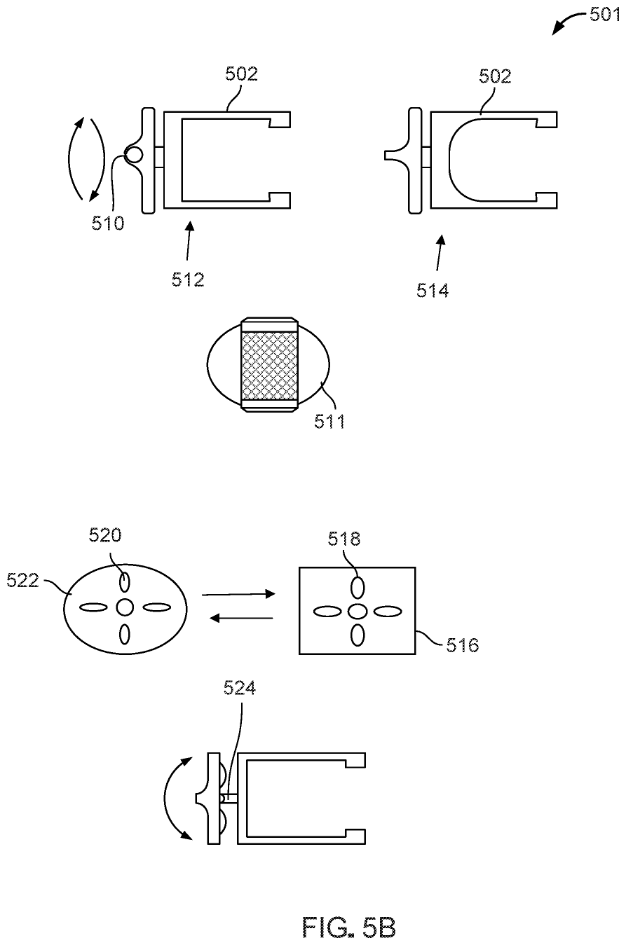

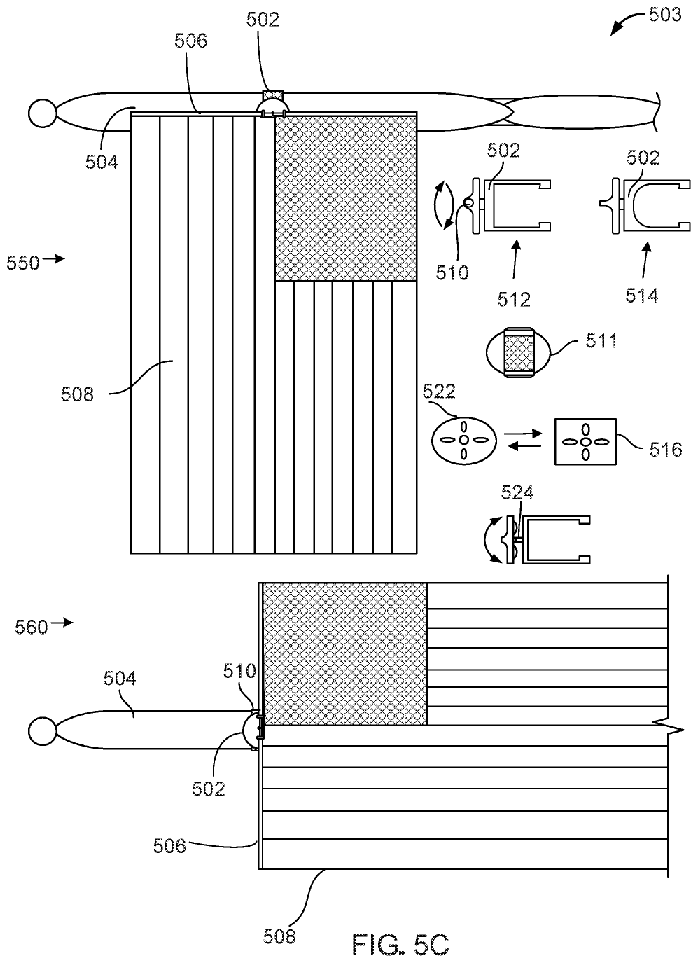

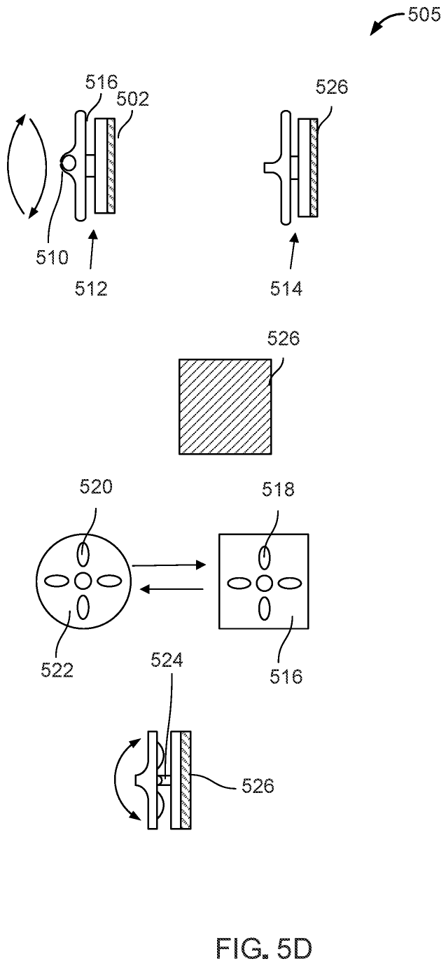

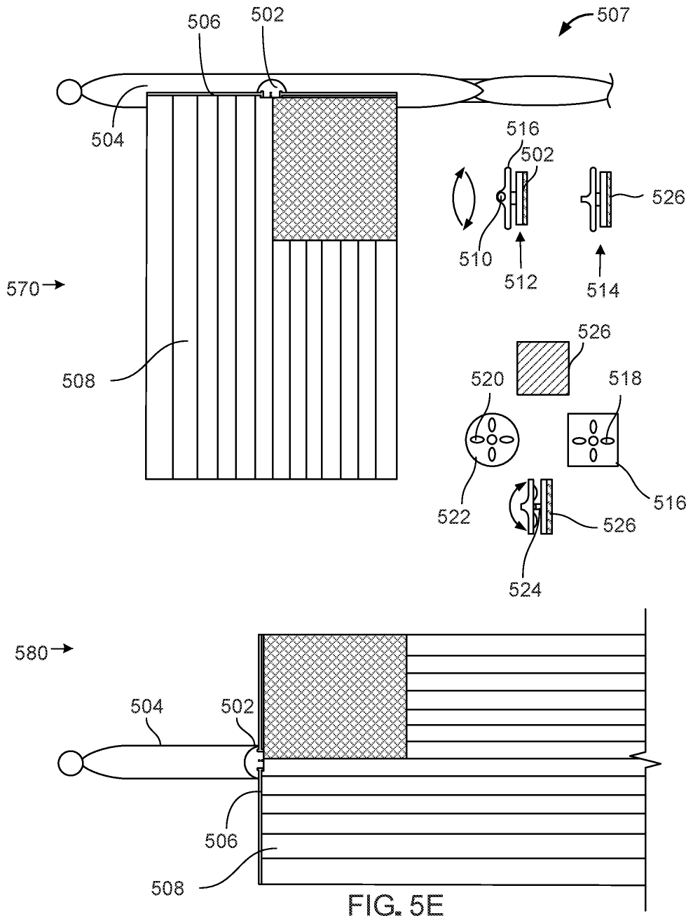

FIG. 5A is a block diagram 500 that illustrates an example of various orientations for coupling a flag to a windshield wiper blade of a vehicle. Specifically, the block diagram 500 illustrates different configurations for orientating a flag, banner, logo, or other, which is coupled or attached to a windshield wiper blade of a vehicle. In some examples, in 502, the flag can be oriented in a vertical direction when coupled or attached to the windshield wiper blade of the vehicle. In some examples, such as in 504, the flag can be oriented in a horizontal direction when coupled or attached to the windshield wiper blade of the vehicle. The systems 400, 401, 403, 405, 407, and 409 illustrate various configurations and attachment mechanisms for coupling the flag and corresponding attachment rod to the windshield wiper blade of the vehicle. Each of the configurations and attachment mechanisms from systems 400, 401, 403, 405, 407, and 409 can be incorporated and applied in block diagram 500. Moreover, and as will be further described below, each of the configurations and attachment mechanisms from block diagrams 500, 501, 503, 505, and 507 can be incorporated and applied in block diagram 500.

FIG. 5B is a block diagram 501 that illustrates an example of various devices utilized for coupling a flag to a windshield wiper blade of a vehicle. Block diagram 501 illustrates various devices which can be used to couple an attachment rod that retains a flag to the windshield wiper blade of a vehicle. For example, and as will be further described below, a flag can be retained by an attachment rod, and the attachment rod can be supported by a rotatable retention bracket 502, which attaches to the windshield wiper blade.

In some implementations, the rotatable retention bracket 502 can be created from a variety of materials and can be of any shape or desired size. Specifically, the rotatable retention bracket 502 can be created from one or more of plastic, metal, wood, rubber, graphite, metal composite, carbon block, fiberglass, or any other suitable material. The rotatable retention bracket 502 can additionally be created from, for example, a hybrid material set combining at least one of plastic, metal, wood, rubber, or some other combination.

In some implementations, the rotatable retention bracket 502 can retain an attachment rod that retains a flag in a bracket slot 510. The rotatable retention bracket 502 can attach to the windshield wiper blade of a particular vehicle. Specifically, the rotatable retention bracket 502 can squeeze, grip, hold, claw, or clamp on the one or more windshield wiper blade of vehicle for attachment. A designer or user of block diagram 501 can attach the rotatable retention bracket 502 to the windshield wiper blade at one or more end locations of the attachment rod. In some examples, the rotatable retention bracket 502 can attach to the windshield wiper blade at other locations along a portion of the windshield wiper blade.

Similarly, the rotatable retention bracket 502 can attach to one or more windshield wiper blades of any vehicle including, but not limited to, a car, truck, trailer, boat, motorcycle, SUV, bus, golf cart, ATV, dune buggy, motor home, construction machinery, wave-runner, tractor, plane, helicopter, a wall, a trailer, a truck bumper, a pipe, or any other kind of object. Similarly, the rotatable retention bracket 502 can attach to one or more devices, object, surface, or other stationary object, such as a gutter on a house, a window ledge, a fence, a window housing, a patio surface, a deck surface, a kitchen countertop surface, or another surface.

In some implementations, a flag can be retained on an attachment rod. Once the attachment rod retains the flag, the attachment rod with the retained flag can be attached, i.e., clamped or squeezed, to the windshield wiper blade with the rotatable retention bracket 502. Specifically, the attachment rod with the retained flag can be snapped into the bracket slot 510 of the rotatable retention bracket 502. In response to snapping the attachment rod with the retained flag into the bracket slot 510 of the rotatable retention bracket 502, a designer or user can attach the rotatable retention bracket 502 with the snapped-in attachment rod and retained flag by clamping the rotatable retention bracket 502 to the windshield wiper blade, for example. The rotatable retention bracket 502 can be attached to the windshield wiper blade using other attachment mechanisms as well. By attaching the rotatable retention bracket 502 to the windshield wiper blade while the rotatable retention bracket 502 retains the attachment rod with the retained flag, the rotatable retention bracket 502 can secure the attachment rod with the retained flag when (i) the windshield wiper blade moves across the windshield of the vehicle and (ii) as the vehicle traverses down a roadway.

In some implementations, the rotatable retention bracket 502 can be rotated between a vertical orientation 512 and a horizontal orientation 514 as illustrated in FIG. 5B. Specifically, a designer or user of block diagram 501 can desire to orient a flag to be displayed on a windshield wiper blade a particular direction, e.g., vertical or horizontal. The designer or user can set the flag to be in a vertical position by setting an orientation of the rotatable retention bracket 502 to be in the vertical orientation 512 position. Similarly, the designer can set the flag to be in a horizontal position by setting an orientation of the rotatable retention bracket 502 to be in the horizontal orientation 514 position. In some examples, the rotatable retention bracket 502 can be rotated 90 degrees to the desirable position or until the designer or user receives feedback, indicating an orientation of the rotatable retention bracket 502 has moved or locked into place. The rotatable retention bracket 502 can rotate a front portion, e.g., portion that includes the bracket slot 510, with respect to the portion that attaches to the windshield wiper blade. In some examples, the rotatable retention bracket 502 can be rotated to a desirable position in between and outside of the vertical and horizontal orientations. In this manner, the flag, which is attached to the rotatable retention bracket 502 attached to the windshield wiper blade, can be set to a desired position, according to set criteria. The component 511 can illustrate a rear view of the rotatable retention bracket 502.

In some implementations, the attachment rod and the retained flag can be removed from the rotatable retention bracket 502 without having to decouple the rotatable retention bracket 502 from the windshield wiper blade. In some examples, a designer or user can detach or unclip the attachment rod and the retained flag from the bracket slot 510 of the rotatable retention bracket 502. In some examples, a designer or user can slide the attachment rod and the retained flag from a side portion of the retention slot of the rotatable retention bracket 502. Other examples for removing the attachment rod and the retained flag are also possible. In some examples, the attachment rod and the retained flag can be removed from the rotatable retention bracket 502 after removing the rotatable retention bracket 502 from the windshield wiper blade. For example, a designer or user can unsnap or detach the rotatable retention bracket 502 from the windshield wiper blade.

In some implementations, the back plate 516 of the rotatable retention bracket 502 can include one or more recessed grooves 518. The one or more recessed grooves 518 allow the one or more protrusion points 520 formed on the front plate 522 of the rotatable retention bracket 502 to engage the one or more recessed grooves 518. Moreover, by enabling the one or more recessed grooves 518 to receive and engage the one or more protrusion points 520, the front plate 522 and the back plate 516 can couple to one another in pre-determined positions. In some examples, front plate 522 and the back plate 516 can connect to one another by a shaft 524. The shaft 524 can ensure the attachment rod with the retained flag in the bracket slot 510 remains in a desired orientation, in increments of 90 degrees. However, other increments are also possible. The shaft 524 can be created from a variety of components. For example, the shaft 524 can be created from one or more of plastic, metal, wood, rubber, graphite, metal composite, carbon block, fiberglass, or any other suitable material. The shaft 524 can additionally be created from, for example, a hybrid material set combining at least one of plastic, metal, wood, rubber, or some other combination.

A height of the bracket slot 510 can be, for example, 0.25 inches or a different height. A height of the rotatable retention bracket 502 can be, for example, 1 inch or a different height. A width of the bracket slot 510 can be, for example, 0.25 inches or a different width. A width of the rotatable retention bracket 502 can be, for example, 1 inch or a different width.

FIG. 5C is a block diagram 503 that illustrates an example of various devices utilized for coupling a flag to a windshield wiper blade of a vehicle. Block diagram 503 illustrates a zoomed in version of the components shown in block diagram 501. Specifically, an attachment rod 506 retains a flag 508. The attachment rod 506 is retained by a bracket slot 510 in a rotatable retention bracket 502. In some examples, the rotatable retention bracket 502 can be mounted at a center portion of the windshield wiper blade 504. In some examples, the rotatable retention bracket 502 can be mounted at another portion of the windshield wiper blade 504. The rotatable retention bracket 502 can be mounted or attached to the windshield wiper blade 504 of a vehicle by clamping or another type of attachment mechanism.

The flag 508 is similar to flag 408. The attachment rod 506 is similar to attachment rod 406. Similarly, the windshield wiper blade 504 is similar to the windshield wiper blade 410. As these components are similar, these components will not be described again here.

In some examples, a shaft 524 can connect a back plate 516 and a front plate 522 of the rotatable retention bracket 502. The shaft 524 can ensure the rotatable retention bracket 502 remains in a desired orientation, e.g., vertical, horizontal, or another orientation. For example, the rotatable retention bracket 502 can be placed in a vertical orientation 512, a horizontal orientation 514, or another desired orientation. The top component 550 illustrates the attachment rod 506, the flag 508, and the rotatable retention bracket 502 in the vertical orientation 512. The bottom component 560 illustrates the pole rod 506, the flag 508, and the rotatable retention bracket 502 in the horizontal orientation 514.

FIG. 5D is a block diagram 505 that illustrates an example of various devices utilized for coupling a flag to a vehicle, such as a vehicle's windshield wiper blade, or other surface of the vehicle, such as a bumper, license plate, window, or other surface. In addition, the devices illustrated in FIG. 5D can be used to couple a flag to any surface, such as a wall, fence, window, or other suitable surface. Block diagram 505 illustrates various devices which can be used to couple an attachment rod that retains a flag to the windshield wiper blade of a vehicle. For example, and as will be further described below, a flag can be retained be an attachment rod, and the attachment rod can be supported by a rotatable retention bracket 502, which attaches to the windshield wiper blade.

Block diagram 505 is similar to block diagram 501. Similar components will not be described again. In block diagram 505, the back plate 516 of the rotatable retention bracket 502 can include a flat backing plate instead of a clamp bracket utilized in block diagram 501. In this manner, the flat backing of the rotatable retention bracket 502 can be adhered to any suitable surface, movable or stationary surface, using any adherence method. For example, the adherence method can include single sided tape, double-sided tape, glue, zip-ties, nails, screws, suction, hook and loop fastener, magnet, or a suitable fastening mechanism. The rotatable retention bracket 502 can adhere to a windshield wiper blade, e.g., windshield wiper blade 504, using one or more of the adherence methods, such as an adhesive backing 526. The other components in block diagram 505 remain similar to the components described with respect to block diagram 501. In some examples, a height and width of the adhesive backing 526 can be, for example, 1 inch, respectively, or different heights and widths.

FIG. 5E is a block diagram 507 that illustrates an example of various devices utilized for coupling a flag to a windshield wiper blade of a vehicle. Block diagram 507 is similar to block diagram 503, with the incorporating of the adherence backing on the rotatable retention device 502 instead of a clamping mechanism, for example. Block diagram 507 illustrates a zoomed in version of the components shown in block diagram 505. Specifically, an attachment rod 506 retains a flag 508. The attachment rod 506 is retained by a bracket slot 510 in a rotatable retention bracket 502. In some examples, the rotatable retention bracket 502 can be mounted at a center portion of the windshield wiper blade 504. In some examples, the rotatable retention bracket 502 can be mounted at another portion of the windshield wiper blade 504. The rotatable retention bracket 502 can be mounted or attached to the windshield wiper blade 504 of a vehicle by one or more of the adherence methods mentioned with respect to block diagram 505.

The flag 508 is similar to flag 408. The attachment rod 506 is similar to pole rod 406. Similarly, the windshield wiper blade 504 is similar to the windshield wiper blade 410. As these components are similar, these components will not be described again here.

In some examples, a shaft 524 can connect a back plate 516 and a front plate 522 of the rotatable retention bracket 502. The shaft 524 can ensure the rotatable retention bracket 502 remains in a desired orientation, e.g., vertical, horizontal, or another orientation. For example, the rotatable retention bracket 502 can be placed in a vertical orientation 512, a horizontal orientation 514, or another desired orientation. The top component 570 illustrates the attachment rod 506, the flag 508, and the rotatable retention bracket 502 in the vertical orientation 512. The bottom component 580 illustrates the attachment rod 506, the flag 508, and the rotatable retention bracket 502 in the horizontal orientation 514.

While this specification contains many specific implementation details, these should not be construed as limitations on the scope of any disclosure or of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings or described in a particular order, this should not be understood as requiring that such operations be performed in the particular order shown or in sequential order, or that all illustrated operations be performed, to achieve desirable results. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results.

What is claimed is:

1. A device comprising:
an attachment rod configured to be coupled to at least two screw holes used to couple a license plate to a vehicle, the attachment rod having defined therein at least two openings configured to correspond to the at least two screw holes and each of the at least two openings is configured to receive one or more attachment components in order to couple the attachment rod to the at least two screw holes; and
a flag comprising an elongated opening defined therein for receiving a portion of the attachment rod through the elongated opening to couple the flag to the attachment rod.

2. The device of claim 1, wherein the flag comprises at least two openings defined therein, the at least two openings of the flag configured to enable the one or more attachment components to pass at least partially through the openings to couple the flag and attachment rod to the at least two screw holes used to couple the license plate to the vehicle.

3. The device of claim 1, wherein the one or more attachment components comprise a base portion configured to be coupled to one of the at least two screw holes used to couple the license plate to the vehicle and an upper portion configured to be releasably coupled to the base portion.

4. The device of claim 1, wherein the attachment rod comprises raised portions at each end of the attachment rod, the raised portions configured to retain the flag on the attachment rod.

5. The device of claim 1, wherein the attachment rod comprises a longitudinal slot defined therein, the longitudinal slot configured to receive a portion of the flag along the elongated opening defined in the flag to couple the flag to the attachment rod.

6. The device of claim 1, wherein the attachment components are configured to releasably couple the attachment rod to the at least two screw holes.

7. A device comprising:
an attachment bracket comprising a first component and a second component, the first component and the second component having defined therein at least two openings configured to correspond to at least two screw holes used to couple a license plate to a vehicle;
an attachment rod configured to be releasably coupled to the first and second components of the attachment bracket; and
a flag comprising an elongated opening defined therein for receiving a portion of the attachment rod through the elongated opening to couple the flag to the attachment rod.

8. The device of claim 7, wherein the flag comprises at least two openings defined therein, the at least two openings of the flag configured to enable coupling of the attachment rod to the first and second components of the attachment bracket.

9. The device of claim 7, further comprising one or more attachment components comprising a base portion configured to be coupled to the attachment bracket and an upper portion configured to releasably couple the attachment rod to the attachment component.

10. The device of claim 7, wherein the attachment rod comprises raised portions at each end of the attachment rod, the raised portions configured to retain the flag on the attachment rod.

11. The device of claim 7, wherein the attachment rod comprises a longitudinal slot defined therein, the longitudinal slot configured to receive a portion of the flag along the elongated opening defined in the flag to couple the flag to the attachment rod.

12. The device of claim 7, wherein the first and second components of the attachment bracket are configured to be coupled to the at least two screw holes in one of a horizontal configuration or vertical configuration.

13. A device comprising:
a plurality of attachment components, the plurality of attachment components each comprising a base portion and an upper portion;
an attachment rod configured to be releasably coupled to the plurality of attachment components between the base portion and upper portion; and
a flag comprising an elongated opening defined therein for receiving a portion of the attachment rod through the elongated opening to couple the flag to the attachment rod.

14. The device of claim 13, wherein the flag comprises at least two openings defined therein, the at least two openings of the flag configured to enable at least one of the plurality of attachment components to pass at least partially through the openings to couple the flag and attachment rod to the at least one of the plurality of attachment components.

15. The device of claim 13, wherein the attachment rod comprises raised portions at each end of the attachment rod, the raised portions configured to retain the flag on the attachment rod.

16. The device of claim 13, wherein the upper portion of the plurality of attachment components is movable with respect to the base portion.

17. The device of claim 13, wherein the upper portion of the plurality of attachment components is substantially D-shaped.

18. The device of claim 13, wherein the base portion comprises one of an adhesive, suction cup, or magnet.

19. A method of attaching a flag to a vehicle comprising:
attaching one or more attachment components to a vehicle surface, the one or more attachment components each comprising a base portion and an upper portion;
passing an attachment rod through an elongated opening defined in a flag; and
releasably coupling the attachment rod and the flag to the one or more attachment components such that the attachment rod is between the base portion and upper portion of the one or more attachment components.

20. The method of claim 19, wherein attaching the one or more attachment components to a vehicle surface comprises a use of an adhesive, suction cup, magnet, snap-fit, or threaded connection.
